(19) United States
(12) Patent Application Publication
(10) Pub. No.: US 2023/0065649 A1
(43) Pub. Date: Mar. 2, 2023

(54) ARTICLES WITH RECYCLE CONTENT HAVING ENDURING PHYSICAL PROPERTIES COMPARABLE TO VIRGIN

(71) Applicant: Eastman Chemical Company, Kingsport, TN (US)

(72) Inventors: Gary Stuart Hawkins, Johnson City, TN (US); Jeremy Hager Klug, Kingsport, TN (US); Thomas Joseph Pecorini, Kingsport, TN (US)

(73) Assignee: Eastman Chemical Company, Kingsport, TN (US)

(21) Appl. No.: 17/818,752

(22) Filed: Aug. 10, 2022

Related U.S. Application Data
(60) Provisional application No. 63/260,202, filed on Aug. 12, 2021.

(51) Int. Cl. C08J 11/24; C08L 101/00; C08J 5/12; C08J 7/04; C08J 9/36

(52) U.S. Cl. CPC C08J 11/24; C08L 101/00; C08J 5/124; C08J 7/04; C08J 9/36; C08L 2205/03; C08L 2207/20; C08L 2207/53; C08J 2467/02; C08J 2401/10

(57) ABSTRACT

A method of making an article of manufacture is disclosed, wherein the article includes a polymer with recycle content. In one or more embodiments, the polymer with recycle content is selected from the group consisting of (i) a recycle content polyester; and (ii) a recycle content cellulose ester.

### FIELD OF THE INVENTION

The present invention is in the general fields of sustainability and circular economy and generally relates to articles of manufacture that include circular economy polymers.

### BACKGROUND OF THE INVENTION

There is a well-known global issue with waste disposal, particularly of large volume consumer products such as plastics, textiles and other polymers that may not be considered biodegradable within current local, state, federal or global standards. Accordingly, there is a public desire to incorporate these types of wastes into new products through recycling, reuse, or otherwise reducing the amount of waste in circulation or in landfills as well as to generally reduce the amount of the virgin form of such materials entering the ecosystem. These desires in turn create a market need for consumer products to contain significant amounts of renewable, recycled, re-used or other materials and to in general improve/reduce fossil fuel consumption, carbon emissions, carbon footprint, waste disposal and other environmental sustainability issues.

In one known recycle method, plastics such as polyethylene terephthalate (PET) may be reclaimed from previous by collecting, crushing or otherwise reducing to particle form, melting and then forming articles from the melt either alone or blended with virgin materials. This “mechanical recycling” approach has been used, for example, to prepare blends of virgin poly(butylene terephthalate) (“PBT”) with recycled PET to yield a PBT-based product with recycle content (see, for example, U.S. Published Patent Application No. 2009/0275698). Recycled polymer blends that are formed from polymer waste, for example, post-consumer polymer waste, post-industrial polymer waste, and/or post-agricultural waste polymer are also known as exemplified in U.S. Published Patent Application No. 2019/0023886. In another known method, described for example in U.S. Pat. No. 5,294,384, thermoplastic compositions may be formed by melt blended a multicomponent material such as whole carpet without separating the material into its component parts.

Though such mechanical recycling approaches may generally facilitate re-use of polymeric materials, they have many drawbacks. For example, PET reclaimers in the industry often limit the raw material they can or accept for mechanical recycling to relatively simple plastic articles comprising a single polymer with limited additives, colors or formulation ingredients. Further, more complex materials are simply not recyclable using mechanical techniques and, even if mechanical recyclable, require a series of expensive processing steps, tight processing windows and the addition of one or more additives such as compatibilizers in order for them to have any basic utility. Even with such effort and expense, such mechanical recycle materials typically possess a number of disadvantages that often make them unsatisfactory (if not wholly unusable) in many markets and applications. For example, mechanical recycle products may include unintended contaminants such as dirt and unanticipated materials present from the original source. Further, wide variations in material sources for producing mechanical recycle materials can create wide intra-lot and lot-to-lot variations in product age, uniformity, consistency, polymer class/structure and the like. Also, many mechanical recycle materials are blends that can be generally immiscible or non-homogenous.

These disadvantages can translate to severely limit commercial use of mechanical recycle materials in articles of manufacture. For example, such materials often exhibit mechanical properties such as tensile, modulus and the like that fail to meet the initial and/or long-term specifications of more demanding applications and that can vary lot by lot if not by package or sample. Physical, visual or optical properties such as surface energy, coatability, adhesion, chemical resistance, weather resistance, thermal resistance, color uniformity, light transmission, haze, general aesthetics and the like can also be inferior and/or vary and will similarly limit use in applications where such characteristics are critical. In particular, specifications and technical requirements related to downstream processing steps such as coating, printing, electroplating, laminating, laser marking, engraving and the like place a significant limiting factor on use of mechanical recycle materials, to an extent that article manufacturers that are strongly incentivized to maximize an article's claimed recycle content must often nonetheless specify materials that exclude mechanical recycle.

Accordingly, an unmet market need remains for articles of manufacture and methods for their production which have maximized polymer recycle content and reduced fossil fuel consumption and carbon footprint while meeting end-use, processing, utility and performance specifications.

### SUMMARY OF THE INVENTION

In a first aspect, the present invention is directed to an article. The article of the present invention includes a polymer with recycle content. In an aspect, the present invention is directed to articles that include a circular economy polymer that attribute (or provide) recycle content to the article. As utilized herein, the phrase “circular economy” is intended to generically describe polymers that, through approaches such as chemical recycling, depolymerization or credit transfer allotment, are manufactured in general support of re-use of existing material sources from the ecosystem in pursuit of environmental benefits such as reduced fossil fuel consumption, carbon emissions, carbon footprint and waste generation and improved overall environmental sustainability. In one or more embodiments, the polymer with recycle content is selected from the group consisting of (i) a recycle content polyester (r-polyester); and (ii) a recycle content cellulose ester (r-CE or r-cellulose ester).

In another aspect, the present invention is directed to a method of making an article having recycle content, said method comprising: (a) procuring a supply of a recycled content polymer, said polymer with recycle content selected from a group consisting of (i) a recycle content copolyester, wherein said recycle content copolyester is a thermoplastic cycloaliphatic copolyester that includes diol residues of 1,4-cyclohexanedimethanol (CHDM) and 2,2,4,4-tetramethyl-1,3-cyclobutanediol (TMCD); and (ii) a recycle content cellulose ester; and (b) forming an article or article component using at least a portion of said polymer with recycle content, wherein the recycle content includes recycle content obtained by processing a feedstock that includes plastic waste and said plastic waste includes no more than 20% by weight reclaimable plastic material.

In another aspect, the present invention is directed to a method for marketing an article with recycle content. In this aspect, the method of the present invention includes: (a) procuring a supply of polymer with recycle content, wherein the polymer with recycle content is preferably selected from a group consisting of (i) a recycle content polyester and (ii) a recycle content cellulose ester; (b) forming an article or article component using at least a portion of said polymer with recycle content; and (c) offering for sale said article with recycle content, said offering step including generally describing said article or said article component as including, made with, made from or using said polymer with recycle content. In one or more embodiments, the recycle content polyester includes a thermoplastic cycloaliphatic copolyester that includes diol residues of 1,4-cyclohexanedimethanol (CHDM) and 2,2,4,4-tetramethyl-1,3-cyclobutanediol (TMCD).

In another aspect, the present invention is directed to a method for reducing the fossil fuel use associated with article manufacture. In embodiments, reducing fossil fuel use can be accomplished by utilizing waste materials, e.g., waste plastic that would typically end up in landfills or otherwise remain in the environment, as a feedstock source in place of a fossil fuel source to make polymers/polymer compositions used to manufacture articles. In this aspect, the method of the present invention includes (a) procuring a supply of polymer with recycle content, wherein the polymer with recycle content is preferably selected from a group consisting of (i) a recycle content polyester and (ii) a recycle content cellulose ester; and (b) forming an article or article component using at least a portion of said polymer with recycled content. In one or more embodiments, the recycle content polyester a thermoplastic cycloaliphatic copolyester that includes diol residues of 1,4-cyclohexanedimethanol (CHDM) and 2,2,4,4-tetramethyl-1,3-cyclobutanediol (TMCD).

In still another aspect, the present invention is directed to a method for manufacture of a circular economy polymer. In this aspect, the method of the present invention includes: (a) receiving allotment transfer credits and (b) allocating said transfer credits to a polymer to provide or increase recycle content in the polymer. In one or more embodiments, the polymer with recycle content of step (b) is a thermoplastic cycloaliphatic copolyester that includes diol residues of 1,4-cyclohexanedimethanol (CHDM) and 2,2,4,4-tetramethyl-1,3-cyclobutanediol (TMCD). In one or more embodiments, the receiving step (a) includes generating allotment transfer credits by processing a feedstock that includes plastic waste, the plastic waste having no more than 20% by weight reclaimable plastic waste.

Further aspects of the invention are as disclosed and claimed herein.

### DETAILED DESCRIPTION

In a first aspect, the present invention is an article or an article of manufacture. As used herein, the phrase “polymer with recycle content” is intended to include one or more of (i) polymer that is formed from feedstock that includes monomer, upstream monomer reactants or other feedstock components formed from a depolymerization process; and (ii) polymer that may be marketed or certified as containing recycle content regardless of monomer, upstream monomer reactant or other feedstock component source. In embodiments, the polymer according to (i) has no more than 10, 8, 6, 4, 2 or 1% by weight unintentional contaminants. A “depolymerization process” is defined to include any process step or series of process steps resulting in the breaking or destruction of a polymer's polymeric structure. In embodiments, the depolymerization process results in the polymer being converted into one or more materials in a form that can be molecules, chemical compounds, monomers, oligomers, or combinations thereof. In embodiments, the feed for the depolymerization process (“depolymerization feed”) comprises waste plastic (or mixed plastic waste) that includes no more than 20% by weight or no more than 15% by weight or no more than 10% by weight or no more than 5% by weight of reclaimed plastic waste. In embodiments, the depolymerization feed comprises waste plastic (or mixed plastic waste) that is difficult (or impossible) to mechanically recycle (i.e., plastic waste that typically ends up in a landfill or remains in the environment, and only contains relatively small amounts of or no reclaimed plastic waste (as described herein) (“Non-mechanical recycle waste plastic”). In embodiments, the non-mechanical recycle waste plastic is chosen from pre-consumer plastic waste that is difficult to mechanically recycle; post-consumer plastic waste that is difficult to mechanically recycle; colored (dye or pigments) PET bottles; plastic carpet fibers, e.g., polyester or PET fibers; synthetic textiles, e.g., polyester or PET textiles; scrap from PET reclaimers, e.g., fines and purge waste from mechanical PET recycle processes; difficult to process polyester compositions, e.g., because of blends with other plastics, fillers or other additives that make the composition difficult to mechanically recycle; ocean bound plastics that are of a type or contain contaminants in the aggregate that make it difficult to mechanically recycle the plastic, or combinations thereof.

In one or more embodiments, the polymer with recycle content does not include, or includes no more than 20% by weight or no more than 15% by weight or no more than 10% by weight or no more than 5% by weight of reclaimed plastic waste. Reclaimed plastic waste is defined as polymer material that is recovered or reclaimed from a previous utility and sourced in substantially polymeric form for re-use. Reclaimed plastic waste includes materials reformed to increase molecular weight or IV, such as through solid state polymerization, but where polymer bonds are not significantly or purposefully broken down. Reclaimed plastic waste is typically processed using mechanical recycling techniques. Reclaimed plastic waste may include materials formed from mechanically recycled, clear PET bottles but may often exclude materials relatively more difficult to process because of for example number, type, complexity and form of components (such as presence of dyes, pigments, fillers or additives) or presence of contaminants. Examples of materials of materials typically not considered “reclaimable”, or useful in forming a “reclaimed” material, include carpet materials and components such a fibers; synthetic textile materials, scrap from PET reclaimers, e.g. fines and purge waste from mechanical recycle processes and ocean bound plastics.

In one or more embodiments, the polymer with recycle content is “substantially comparable” to a “matching virgin” polymer. The phrase “substantially comparable”, as used herein, means that, for a given measurable polymer property, the polymer with recycle content exhibits a numeric value within 5% or 4% or 3% or 2% or 1% of the value exhibited by the matching virgin polymer for that property. The phrase “matching virgin” polymer, as used herein, means a polymer formed from monomeric repeat units and repeat unit amounts equivalent to those of the polymer with recycle content but which are sourced from new, non-recycled materials such as fossil fuels. Polymer properties that may be utilized for comparison of polymers with recycle content to matching virgin polymers, and test methods for determining the numeric values of those properties, are not necessarily limited and include without limitation properties described or set forth in Tables herein.

In one or more embodiments, the polymer with recycle content may be a component of a recycle polymer composition or a recycle polymer blend. In such embodiments, the polymer with recycle content is present in said article in an amount of at least 50% by weight or at least 75% by weight or at least 95% by weight or 100% based on the total weight of the article or the total weight of the composition or blend or the total weight of an article component as described elsewhere herein. The polymer compositions or polymer blends may further include other components or additives. Polymer with recycle content that is formed from feedstock that includes monomer, upstream monomer reactants or other feedstock components from a depolymerization process may be referred to herein as “physical recycle content polymer”.

In one or more embodiments, the polymer with recycle content may be component of a recycle polymer composition or a recycle polymer blend. In such embodiments, the polymer with recycle content may be present in an amount of at least 5% by weight or at least 10% by weight or at least 15% by weight or at least 20% by weight or at least 25% by weight or at least 30% by weight or at least 35% by weight or at least 40% by weight or at least 45% by weight or at least 50% by weight or at least 55% by weight or at least 60% by weight or at least 65% by weight or at least 70% by weight or at least 75% by weight or at least 80% by weight or at least 85% by weight or at least 90% by weight or at least 95% by weight based on the total weight of the recycle composition article or the total weight of the composition or blend. In one or more embodiments, the polymer with recycle content may be present in an amount of at least 5% by weight or at least 10% by weight or at least 15% by weight or at least 20% by weight or at least 25% by weight or at least 30% by weight or at least 35% by weight or at least 40% by weight or at least 45% by weight or at least 50% by weight or at least 55% by weight or at least 60% by weight or at least 65% by weight or at least 70% by weight or at least 75% by weight or at least 80% by weight or at least 85% by weight or at least 90% by weight or at least 95% by weight based on the total weight of the article.

The recycle polymer compositions or recycle polymer blends may further include other components or additives. In one or more embodiments, components of recycle polymer compositions include additives or components with recycle content.

In one or more embodiments, the polymer with recycle content may be selected from the group consisting of (i) a recycle content polyester and (ii) a recycle content cellulose ester. In one or more embodiments, the polymer with recycle content may include a recycle content polyester. Non-limiting examples of recycle content polyester may include recycle content polyethylene terephthalate (PET); recycle content polycyclohexylenedimethylene terephthalate (PCT); recycle content glycol modified polyethylene terephthalate (PETG) including PET modified with 1,4-cyclohexanedimethanol, 2,2,4,4-tetramethyl-1,3-cyclobutanediol, isosorbide, or combinations thereof; and glycol modified polycyclohexylenedimethylene terephthalate including modified with 2,2,4,4-tetramethyl-1,3-cyclobutanediol (PCTM). In one or more embodiments, the recycle content polyester includes a recycle content thermoplastic cycloaliphatic copolyester including or with diol residues of 1,4-cyclohexanedimethanol (CHDM) and 2,2,4,4-tetramethyl-1,3-cyclobutanediol (TMCD). Thermoplastic cycloaliphatic copolyesters that include diol residues of 1,4-cyclohexanedimethanol (CHDM) and 2,2,4,4-tetramethyl-1,3-cyclobutanediol (TMCD) have been described for example in U.S. Pat. Nos. 7,737,246 and 7,985,827, assigned to the assignee of the present invention, the contents and disclosure of which are hereby incorporated herein by reference.

In one or more embodiments, particularly in embodiments wherein the polymer with recycle content is a recycle content polyester, monomer or upstream monomer reactants or other feedstock components formed from a depolymerization process may include one or more diacids, such as DMT (dimethyl terephthalate), TPA (terephthalic acid), IPA (isophthalic acid), FDCA (furandicarboxylic acid, e.g., 2,5-furandicarboxyilc acid), and/or one or more diols, such as Cl to C4 alkyl-diols (ethylene glycol (EG), propane diol, butane diol), CHDM, TMCD, and isosorbide.

In some embodiments, a recycle content polyester may be a component of a recycle content polyester (r-polyester) composition.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 10 to 99 mole % of 2,2,4,4-tetramethyl-1,3-cyclobutanediol (TMCD) residues; and
   ii) 1 to 90 mole % of 1,4-cyclohexanedimethanol (CHDM) residues, wherein the total mole % of the dicarboxylic acid component is 100 mole %, the total mole % of the glycol component is 100 mole %; and
   wherein the inherent viscosity of the polyester is from 0.1 to 1.2 dL/g as determined in 60/40 (wt/wt) phenol/tetrachloroethane at a concentration of 0.5 g/100 ml at 25° C.; and wherein the polyester has a Tg of from 100 to 200° C.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 70 mole % of 2,2,4,4-tetramethyl-1,3-cyclobutanediol residues; and
   ii) 30 to 85 mole % of 1,4-cyclohexanedimethanol residues, wherein the total mole % of the dicarboxylic acid component is 100 mole %, the total mole % of the glycol component is 100 mole %; and
      wherein the inherent viscosity of the polyester is from 0.35 to 1.2 dL/g as determined in 60/40 (wt/wt) phenol/tetrachloroethane at a concentration of 0.5 g/100 ml at 25° C.; and wherein the polyester has a Tg of from 100 to 160° C.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 20 to 40 mole % of 2,2,4,4-tetramethyl-1,3-cyclobutanediol residues; and
   ii) 60 to 80 mole % of 1,4-cyclohexanedimethanol residues, wherein the total mole % of the dicarboxylic acid component is 100 mole %, the total mole % of the glycol component is 100 mole %; and
wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 100 to 120° C.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 40 to 55 mole % of 2,2,4,4-tetramethyl-1,3-cyclobutanediol residues; and
   ii) 45 to 60 mole % of 1,4-cyclohexanedimethanol residues, wherein the total mole % of the dicarboxylic acid component is 100 mole %, the total mole % of the glycol component is 100 mole %; and
      wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 120 to 140° C.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 70 mole % of 2,2,4,4-tetramethyl-1,3-cyclobutanediol residues; and
   ii) 30 to 85 mole % of 1,4-cyclohexanedimethanol residues, wherein the total mole % of the dicarboxylic acid component is 100 mole %, the total mole % of the glycol component is 100 mole %; and
      wherein the inherent viscosity of the polyester is from 0.35 to 0.85 dL/g as determined in 60/40 (wt/wt) phenol/tetrachloroethane at a concentration of 0.5 g/100 ml at 25° C.; and wherein the polyester has a Tg of from 100 to 140° C.

In embodiments, the r-polyester composition comprises at least one recycle content polyester, which comprises:
(a) a dicarboxylic acid component comprising:
   i) 70 to 100 mole % of terephthalic acid residues;
   ii) 0 to 30 mole % of aromatic dicarboxylic acid residues having up to 20 carbon atoms; and
   iii) 0 to 10 mole % of aliphatic dicarboxylic acid residues having up to 16 carbon atoms; and
(b) a glycol component comprising:
   i) 15 to 90 mole % of 2,2,4,4-tetramethyl-1,3-cyclobutanediol residues; and
   ii) 10 to 85 mole % of 1,4-cyclohexanedimethanol residues, wherein the total mole % of the dicarboxylic acid component is 100 mole %, the total mole % of the glycol component is 100 mole %; and
      wherein the inherent viscosity of the polyester is from 0.1 to 1.2 dL/g as determined in 60/40 (wt/wt) phenol/tetrachloroethane at a concentration of 0.5 g/100 ml at 25° C.; and wherein the polyester has a Tg of from 100 to 200° C.

In embodiments, any one of the recycle content polyesters or r-polyester compositions described herein can further comprise residues of at least one branching agent. In embodiments, any one of the recycle content polyesters or r-polyester compositions described herein can comprise at least one thermal stabilizer or reaction products thereof.

In embodiments, the r-polyester composition includes at least one polycarbonate. In other embodiments, the r-polyester composition contains no polycarbonate.

In embodiments, the recycle content polyesters can contain less than 15 mole % ethylene glycol residues, such as, for example, 0.01 to less than 15 mole % ethylene glycol residues. In embodiments, the polyesters useful in the invention contain less than 10 mole %, or less than 5 mole %, or less than 4 mole %, or less than 2 mole %, or less than 1 mole % ethylene glycol residues, such as, for example, 0.01 to less than 10 mole %, or 0.01 to less than 5 mole %, or 0.01 to less than 4 mole %, or 0.01 to less than 2 mole %, or 0.01 to less than 1 mole %, ethylene glycol residues. In one embodiment, the polyesters useful in the invention contain no ethylene glycol residues.

In embodiments, the glycol component for the recycle content polyesters can include but is not limited to at least one of the following combinations of ranges: 10 to 99 mole % 2,2,4,4-tetramethyl-1,3-cyclobutanediol and 1 to 90 mole % 1,4-cyclohexanedimethanol; 10 to 95 mole % 2,2,4,4-tetramethyl-1,3-cyclobutanediol and 5 to 90 mole % 1,4-cyclohexanedimethanol; 10 to 90 mole % 2,2,4,4-tetramethyl-1,3-cyclobutanediol and 10 to 90 mole % 1,4-cyclohexanedimethanol; 10 to 85 mole % 2,2,4,4-tetramethyl-1,3-cyclobutanediol and 15 to 90 mole % 1,4-cyclohexanedimethanol; 10 to 80 mole % 2,2,4,4-tetramethyl-1,3-cyclobutanediol and 20 to 90 mole % 1,4-cyclohexanedimethanol, 10 to 75 mole % 2,2,4,4-tetramethyl-1,3-cyclobutanediol and 25 to 90 mole % 1,4-cyclohexanedimethanol; 10 to 70 mole % 2,2,4,4-tetramethyl-1,3-cyclobutanediol and 30 to 90 mole % 1,4-cyclohexanedimethanol; 10 to 65 mole % 2,2,4,4-tetramethyl-1,3-cyclobutanediol and 35 to 90 mole % 1,4-cyclohexanedimethanol; 10 to 60 mole % 2,2,4,4-tetramethyl-1,3-cyclobutanediol and 40 to 90 mole % 1,4-cyclohexanedimethanol; 10 to 55 mole % 2,2,4,4-tetramethyl-1,3-cyclobutanediol and 45 to 90 mole % 1,4-cyclohexanedimethanol; 10 to 50 mole % 2,2,4,4-tetramethyl-1,3-cyclobutanediol and 50 to 90 mole % 1,4-cyclohexanedimethanol; 10 to less than 50 mole % 2,2,4,4-tetramethyl-1,3-cyclobutanediol and greater than 50 to 90 mole % 1,4-cyclohexanedimethanol; 10 to 45 mole % 2,2,4,4-tetramethyl-1,3-cyclobutanediol and 55 to 90 mole % 1,4-cyclohexanedimethanol; 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to less than 35 mole % 2,2,4,4-tetramethyl-1,3-cyclobutanediol and greater than 65 up to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and greater than 75 to 90 mole % 1,4-cyclohexanedimethanol; 11 to 25 mole % 2,2,4,4-tetramethyl-1,3-cyclobutanediol and 75 to 89 mole % 1,4-cyclohexanedimethanol; 12 to 25 mole % 2,2,4,4-tetramethyl-1,3-cyclobutanediol and 75 to 88 mole % 1,4-cyclohexanedimethanol; and 13 to 25 mole % 2,2,4,4-tetramethyl-1,3-cyclobutanediol and 75 to 87 mole % 1,4-cyclohexanedimethanol.

In other embodiments, the glycol component for the recycle content polyesters can include but is not limited to at least one of the following combinations of ranges: 14 to 99 mole % 2,2,4,4-tetramethyl-1,3-cyclobutanediol and 1 to 86 mole % 1,4-cyclohexanedimethanol; 14 to 95 mole % 2,2,4,4-tetramethyl-1,3-cyclobutanediol and 5 to 86 mole % 1,4-cyclohexanedimethanol; 14 to 90 mole % 2,2,4,4-tetramethyl-1,3-cyclobutanediol and 10 to 86 mole % 1,4-cyclohexanedimethanol; 14 to 85 mole % 2,2,4,4-tetramethyl-1,3-cyclobutanediol and 15 to 86 mole % 1,4-cyclohexanedimethanol; 14 to 80 mole % 2,2,4,4-tetramethyl-1,3-cyclobutanediol and 20 to 86 mole % 1,4-cyclohexanedimethano1,14 to 75 mole % 2,2,4,4-tetramethyl-1,3-cyclobutanediol and 25 to 86 mole % 1,4-cyclohexanedimethanol; 14 to 70 mole % 2,2,4,4-tetramethyl-1,3-cyclobutanediol and 30 to 86 mole % 1,4-cyclohexanedimethanol; 14 to 65 mole % 2,2,4,4-tetramethyl-1,3-cyclobutanediol and 35 to 86 mole % 1,4-cyclohexanedimethanol; 14 to 60 mole % 2,2,4,4-tetramethyl-1,3-cyclobutanediol and 40 to 86 mole % 1,4-cyclohexanedimethanol; 14 to 55 mole % 2,2,4,4-tetramethyl-1,3-cyclobutanediol and 45 to 86 mole % 1,4-cyclohexanedimethanol; and 14 to 50 mole % 2,2,4,4-tetramethyl-1,3-cyclobutanediol and 50 to 86 mole % 1,4-cyclohexanedimethanol.

In other embodiments, the glycol component for the recycle content polyesters can include but is not limited to at least one of the following combinations of ranges: 15 to 99 mole % 2,2,4,4-tetramethyl-1,3-cyclobutanediol and 1 to 85 mole % 1,4-cyclohexanedimethanol; 15 to 95 mole % 2,2,4,4-tetramethyl-1,3-cyclobutanediol and 5 to 85 mole % 1,4-cyclohexanedimethanol; 15 to 90 mole % 2,2,4,4-tetramethyl-1,3-cyclobutanediol and 10 to 85 mole % 1,4-cyclohexanedimethanol; 15 to 85 mole % 2,2,4,4-tetramethyl-1,3-cyclobutanediol and 15 to 85 mole % 1,4-cyclohexanedimethanol; 15 to 80 mole % 2,2,4,4-tetramethyl-1,3-cyclobutanediol and 20 to 85 mole % 1,4-cyclohexanedimethanol, 15 to 75 mole % 2,2,4,4-tetramethyl-1,3-cyclobutanediol and 25 to 85 mole % 1,4-cyclohexanedimethanol; 15 to 70 mole % 2,2,4,4-tetramethyl-1,3-cyclobutanediol and 30 to 85 mole % 1,4-cyclohexanedimethanol; 15 to 65 mole % 2,2,4,4-tetramethyl-1,3-cyclobutanediol and 35 to 85 mole % 1,4-cyclohexanedimethanol; 15 to 60 mole % 2,2,4,4-tetramethyl-1,3-cyclobutanediol and 40 to 85 mole % 1,4-cyclohexanedimethanol; 15 to 55 mole % 2,2,4,4-tetramethyl-1,3-cyclobutanediol and 45 to 85 mole % 1,4-cyclohexanedimethanol; and 15 to 50 mole % 2,2,4,4-tetramethyl-1,3-cyclobutanediol and 50 to 85 mole % 1,4-cyclohexanedimethanol.

In other embodiments, the glycol component for the recycle content polyesters can include but is not limited to at least one of the following combinations of ranges: 15 to less than 50 mole % 2,2,4,4-tetramethyl-1,3-cyclobutanediol and greater than 50 up to 85 mole % 1,4-cyclohexanedimethanol; 15 to 45 mole % 2,2,4,4-tetramethyl-1,3-cyclobutanediol and 55 to 85 mole % 1,4-cyclohexanedimethanol; 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In other embodiments, the glycol component for the recycle content polyesters can include but is not limited to at least one of the following combinations of ranges: 20 to 99 mole % 2,2,4,4-tetramethyl-1,3-cyclobutanediol and 1 to 80 mole % 1,4-cyclohexanedimethanol; 20 to 95 mole % 2,2,4,4-tetramethyl-1,3-cyclobutanediol and 5 to 80 mole % 1,4-cyclohexanedimethanol; 20 to 90 mole % 2,2,4,4-tetramethyl-1,3-cyclobutanediol and 10 to 80 mole % 1,4-cyclohexanedimethanol; 20 to 85 mole % 2,2,4,4-tetramethyl-1,3-cyclobutanediol and 15 to 80 mole % 1,4-cyclohexanedimethanol; 20 to 80 mole % 2,2,4,4-tetramethyl-1,3-cyclobutanediol and 20 to 80 mole % 1,4-cyclohexanedimethanol, 20 to 75 mole % 2,2,4,4-tetramethyl-1,3-cyclobutanediol and 25 to 80 mole % 1,4-cyclohexanedimethanol; 20 to 70 mole % 2,2,4,4-tetramethyl-1,3-cyclobutanediol and 30 to 80 mole % 1,4-cyclohexanedimethanol; 20 to 65 mole % 2,2,4,4-tetramethyl-1,3-cyclobutanediol and 35 to 80 mole % 1,4-cyclohexanedimethanol; 20 to 60 mole % 2,2,4,4-tetramethyl-1,3-cyclobutanediol and 40 to 80 mole % 1,4-cyclohexanedimethanol; 20 to 55 mole % 2,2,4,4-tetramethyl-1,3-cyclobutanediol and 45 to 80 mole % 1,4-cyclohexanedimethanol; 20 to 50 mole % 2,2,4,4-tetramethyl-1,3-cyclobutanediol and 50 to 80 mole % 1,4-cyclohexanedimethanol; 20 to 45 mole % 2,2,4,4-tetramethyl-1,3-cyclobutanediol and 55 to 80 mole % 1,4-cyclohexanedimethanol; 20 to 40 mole % 2,2,4,4-tetramethyl-1,3-cyclobutanediol and 60 to 80 mole % 1,4-cyclohexanedimethanol; 20 to 35 mole % 2,2,4,4-tetramethyl-1,3-cyclobutanediol and 65 to 80 mole % 1,4-cyclohexanedimethanol; 20 to 30 mole % 2,2,4,4-tetramethyl-1,3-cyclobutanediol and 70 to 80 mole % 1,4-cyclohexandimethanol; and 20 to 25 mole % 2,2,4,4-tetramethyl-1,3-cyclobutanediol and 75 to 80 mole % 1,4-cyclohexanedimethanol.

In other embodiments, the glycol component for the recycle content polyesters can include but is not limited to at least one of the following combinations of ranges: 25 to 99 mole % 2,2,4,4-tetramethyl-1,3-cyclobutanediol and 1 to 75 mole % 1,4-cyclohexanedimethanol; 25 to 95 mole % 2,2,4,4-tetramethyl-1,3-cyclobutanediol and 5 to 75 mole % 1,4-cyclohexanedimethanol; 25 to 90 mole % 2,2,4,4-tetramethyl-1,3-cyclobutanediol and 10 to 75 mole % 1,4-cyclohexanedimethanol; 25 to 85 mole % 2,2,4,4-tetramethyl-1,3-cyclobutanediol and 15 to 75 mole % 1,4-cyclohexanedimethanol; 25 to 80 mole % 2,2,4,4-tetramethyl-1,3-cyclobutanediol and 20 to 75 mole % 1,4-cyclohexanedimethanol, 25 to 75 mole % 2,2,4,4-tetramethyl-1,3-cyclobutanediol and 25 to 75 mole % 1,4-cyclohexanedimethanol; 25 to 70 mole % 2,2,4,4-tetramethyl-1,3-cyclobutanediol and 30 to 75 mole % 1,4-cyclohexanedimethanol; 25 to 65 mole % 2,2,4,4-tetramethyl-1,3-cyclobutanediol and 35 to 75 mole % 1,4-cyclohexanedimethanol; 25 to 60 mole % 2,2,4,4-tetramethyl-1,3-cyclobutanediol and 40 to 75 mole % 1,4-cyclohexanedimethanol; 25 to 55 mole % 2,2,4,4-tetramethyl-1,3-cyclobutanediol and 45 to 75 mole % 1,4-cyclohexanedimethanol; 25 to 50 mole % 2,2,4,4-tetramethyl-1,3-cyclobutanediol and 50 to 75 mole % 1,4-cyclohexanedimethanol; 25 to 45 mole % 2,2,4,4-tetramethyl-1,3-cyclobutanediol and 55 to 75 mole % 1,4-cyclohexanedimethanol; 25 to 40 mole % 2,2,4,4-tetramethyl-1,3-cyclobutanediol and 60 to 75 mole % 1,4-cyclohexanedimethanol; 25 to 35 mole % 2,2,4,4-tetramethyl-1,3-cyclobutanediol and 65 to 75 mole % 1,4-cyclohexanedimethanol; and 25 to 30 mole % 2,2,4,4-tetramethyl-1,3-cyclobutanediol and 70 to 75 mole % 1,4-cyclohexanedimethanol.

In other embodiments, the glycol component for the recycle content polyesters can include but is not limited to at least one of the following combinations of ranges: 30 to 99 mole % 2,2,4,4-tetramethyl-1,3-cyclobutanediol and 1 to 70 mole % 1,4-cyclohexanedimethanol; 30 to 95 mole % 2,2,4,4-tetramethyl-1,3-cyclobutanediol and 5 to 70 mole % 1,4-cyclohexanedimethanol; 30 to 90 mole % 2,2,4,4-tetramethyl-1,3-cyclobutanediol and 10 to 70 mole % 1,4-cyclohexanedimethanol; 30 to 85 mole % 2,2,4,4-tetramethyl-1,3-cyclobutanediol and 15 to 70 mole % 1,4-cyclohexanedimethanol; 30 to 80 mole % 2,2,4,4-tetramethyl-1,3-cyclobutanediol and 20 to 70 mole % 1,4-cyclohexanedimethanol, 30 to 75 mole % 2,2,4,4-tetramethyl-1,3-cyclobutanediol and 25 to 70 mole % 1,4-cyclohexanedimethanol; 30 to 70 mole % 2,2,4,4-tetramethyl-1,3-cyclobutanediol and 30 to 70 mole % 1,4-cyclohexanedimethanol; 30 to 65 mole % 2,2,4,4-tetramethyl-1,3-cyclobutanediol and 35 to 70 mole % 1,4-cyclohexanedimethanol; 30 to 60 mole % 2,2,4,4-tetramethyl-1,3-cyclobutanediol and 40 to 70 mole % 1,4-cyclohexanedimethanol; 30 to 55 mole % 2,2,4,4-tetramethyl-1,3-cyclobutanediol and 45 to 70 mole % 1,4-cyclohexanedimethanol; 30 to 50 mole % 2,2,4,4-tetramethyl-1,3-cyclobutanediol and 50 to 70 mole % 1,4-cyclohexanedimethanol; 30 to less than 50 mole % 2,2,4,4-tetramethyl-1,3-cyclobutanediol and greater than 50 to 70 mole % 1,4-cyclohexanedimethanol; 30 to 45 mole % 2,2,4,4-tetramethyl-1,3-cyclobutanediol and 55 to 70 mole % 1,4-cyclohexanedimethanol; 30 to 40 mole % 2,2,4,4-tetramethyl-1,3-cyclobutanediol and 60 to 70 mole % 1,4-cyclohexanedimethanol; 30 to 35 mole % 2,2,4,4-tetramethyl-1,3-cyclobutanediol and 65 to 70 mole % 1,4-cyclohexanedimethanol.

In addition to the diols set forth above, in certain embodiments the recycle content polyesters may also be made from 1,3-propanediol, 1,4-butanediol, or mixtures thereof. It is contemplated that materials and/or compositions made from 1,3-propanediol, 1,4-butanediol, or mixtures thereof can possess at least one of the Tg ranges described herein, at least one of the inherent viscosity ranges described herein, and/or at least one of the glycol or diacid ranges described herein. In addition or in the alternative, the recycle content polyesters made from 1,3-propanediol or 1,4-butanediol or mixtures thereof may also be made from 1,4-cyclohexanedmethanol in at least one of the following amounts: from 0.1 to 99 mole %; from 0.1 to 90 mole %; from 0.1 to 80 mole %; from 0.1 to 70 mole %; from 0.1 to 60 mole %; from 0.1 to 50 mole %; from 0.1 to 40 mole %; from 0.1 to 35 mole %; from 0.1 to 30 mole %; from 0.1 to 25 mole %; from 0.1 to 20 mole %; from 0.1 to 15 mole %; from 0.1 to 10 mole %; from 0.1 to 5 mole %; from 1 to 99 mole %; from 1 to 90 mole %, from 1 to 80 mole %; from 1 to 70 mole %; from 1 to 60 mole %; from 1 to 50 mole %; from 1 to 40 mole %; from 1 to 35 mole %; from 1 to 30 mole %; from 1 to 25 mole %; from 1 to 20 mole %; from 1 to 15 mole %; from 1 to 10 mole %; from 1 to 5 mole %; from 5 to 99 mole %, from 5 to 90 mole %, from 5 to 80 mole %; 5 to 70 mole %; from 5 to 60 mole %; from 5 to 50 mole %; from 5 to 40 mole %; from 5 to 35 mole %; from 5 to 30 mole %; from 5 to 25 mole %; from 5 to 20 mole %; and from 5 to 15 mole %; from 5 to 10 mole %; from 10 to 99 mole %; from 10 to 90 mole %; from 10 to 80 mole %; from 10 to 70 mole %; from 10 to 60 mole %; from 10 to 50 mole %; from 10 to 40 mole %; from 10 to 35 mole %; from 10 to 30 mole %; from 10 to 25 mole %; from 10 to 20 mole %; from 10 to 15 mole %; from 20 to 99 mole %; from 20 to 90 mole %; from 20 to 80 mole %; from 20 to 70 mole %; from 20 to 60 mole %; from 20 to 50 mole %; from 20 to 40 mole %; from 20 to 35 mole %; from 20 to 30 mole %; and from 20 to 25 mole.

In certain embodiments, the glycol component of the recycle content polyester can contain 25 mole % or less of one or more modifying glycols which are not 2,2,4,4-tetramethyl-1,3-cyclobutanediol or 1,4-cyclohexanedimethanol; in one embodiment, the polyesters useful in the invention may contain less than 15 mole % of one or more modifying glycols. In another embodiment, the polyesters can contain 10 mole % or less of one or more modifying glycols. In another embodiment, the polyesters can contain 5 mole % or less of one or more modifying glycols. In another embodiment, the polyesters can contain 3 mole % or less of one or more modifying glycols. In another embodiment, the polyesters can contain 0 mole % modifying glycols. Certain embodiments can also contain 0.01 or more mole %, such as 0.1 or more mole %, 1 or more mole %, 5 or more mole %, or 10 or more mole % of one or more modifying glycols. Thus, if present, it is contemplated that the amount of one or more modifying glycols can range from any of these preceding endpoint values including, for example, from 0.01 to 15 mole % and from 0.1 to 10 mole %.

In embodiments, modifying glycols useful in the recycle content polyesters refer to diols other than 2,2,4,4,-tetramethyl-1,3-cyclobutanediol and 1,4-cyclohexanedimethanol and may contain 2 to 16 carbon atoms. Examples of suitable modifying glycols in certain embodiments include, but are not limited to, ethylene glycol, 1,2-propanediol, 1,3-propanediol, neopentyl glycol, 1,4-butanediol, 1,5-pentanediol, 1,6-hexanediol, p-xylene glycol or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

In embodiments, the polyesters and/or the polycarbonates (if included) useful in the r-polyester compositions can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester.

Embodiments for r-polyesters containing TMCD and EG residues (referred to herein from time to time as copolyesters):

In other embodiments, the r-polyesters can include a copolyester comprising: (a) diacid residues comprising from about 90 to 100 mole percent of TPA residues and from 0 to about 10 mole percent IPA residues; and (b) diol residues comprising at least 58 mole percent of EG residues and up to 42 mole percent of TMCD residues, wherein the copolyester comprises a total of 100 mole percent diacid residues and a total of 100 mole percent diol residues.

In embodiments, the r-polyester comprises diol residues comprising from 5 to 42 mole percent TMCD residues and 58 to 95 mole percent EG residues. In one embodiment, the r-polyester comprises diol residues comprising 5 to 40 mole percent TMCD residues and 60 to 95 mole percent EG residues.

In embodiments, the r-polyester comprises diol residues comprising 20 to 37 mole percent TMCD residues and 63 to 80 mole percent EG residues. In one embodiment, the copolyester comprises diol residues comprising 22 to 35 mole percent TMCD residues and 65 to 78 mole percent EG residues.

In embodiments, the r-polyester comprises: a) a dicarboxylic acid component comprising: (i) 90 to 100 mole% terephthalic acid residues; and (ii) about 0 to about 10 mole % of aromatic and/or aliphatic dicarboxylic acid residues having up to 20 carbon atoms; and (b) a glycol component comprising: (i) about 10 to about 27 mole % 2,2,4,4-tetramethyl-1,3-cyclobutanediol (TMCD) residues; and (ii) about 90 to about 73 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.8 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component of the copolyester comprises: (i) about 15 to about 25 mole % 2,2,4,4-tetramethyl-1,3-cyclobutanediol (TMCD) residues; and (ii) about 85 to about 75 mole % ethylene glycol residues; or (i) about 20 to about 25 mole % 2,2,4,4-tetramethyl-1,3-cyclobutanediol (TMCD) residues; and (ii) about 80 to about 75 mole % ethylene glycol residues; or (i) about 21 to about 24 mole % 2,2,4,4-tetramethyl-1,3-cyclobutanediol (TMCD) residues; and (ii) about 86 to about 79 mole % ethylene glycol residues.

In one aspect, the r-polyester is a copolyester comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising:
   (i) about 10 to about 27 mole % 2,2,4,4-tetramethyl-1,3-cyclobutanediol residues; and
   (ii) about 73 to about 90 mole % ethylene glycol residues, and
   (iii) less than about 5 mole %, or less than 2 mole%, of any other modifying glycols;
      wherein the total mole % of the dicarboxylic acid component is 100 mole %, and
      wherein the total mole % of the glycol component is 100 mole %; and
      wherein the inherent viscosity of the copolyester is from 0.50 to 0.8 dL/g as determined in 60/40 (wt/wt) phenol/tetrachloroethane at a concentration of 0.25 g/50 ml at 25° C.

In embodiments, the copolyester has at least one of the following properties chosen from: a T_{g} of from about 90 to about 108° C. as measured by a TA 2100 Thermal Analyst Instrument at a scan rate of 20° C./min, a flexural modulus at 23° C. of greater than about 2000 MPa (290,000 psi) as defined by ASTM D790, and a notched Izod impact strength greater than about 25 J/m (0.47 ft-lb/in) according to ASTM D256 with a 10-mil notch using a ⅛-inch thick bar at 23° C. In one embodiment, the L* color values for the copolyester is 90 or greater, or greater than 90, as determined by the L*a*b* color system measured following ASTM D 6290-98 and ASTM E308-99, performed on polymer granules ground to pass a 1 mm sieve.

In one embodiment, the copolyester further comprises: (II) a catalyst/stabilizer component comprising: (i) titanium atoms in the range of 10-50 ppm based on polymer weight, (ii) optionally, manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In embodiments, the glycol component for the copolyester can include but are not limited to at least one of the following combinations of ranges: about 10 to about 30 mole % 2,2,4,4-tetramethyl-1,3-cyclobutanediol and about 90 to about 70 mole % ethylene glycol; about 10 to about 27 mole % 2,2,4,4-tetramethyl-1,3-cyclobutanediol and about 90 to about 73 mole % ethylene glycol; about 15 to about 26 mole % 2,2,4,4-tetramethyl-1,3-cyclobutanediol and about 85 to about 74 mole % ethylene glycol; about 18 to about 26 mole % 2,2,4,4-tetramethyl-1,3-cyclobutanediol and about 82 to about 77 mole % ethylene glycol; about 20 to about 25 mole % 2,2,4,4-tetramethyl-1,3-cyclobutanediol and about 80 to about 75 mole % ethylene glycol; about 21 to about 24 mole % 2,2,4,4-tetramethyl-1,3-cyclobutanediol and about 79 to about 76 mole % ethylene glycol; or about 22 to about 24 mole % 2,2,4,4-tetramethyl-1,3-cyclobutanediol and about 78 to about 76 mole % ethylene glycol.

In certain embodiments, the copolyesters may exhibit at least one of the following inherent viscosities as determined in 60/40 (wt/wt) phenol/tetrachloroethane at a concentration of 0.25 g/50 ml at 25° C. from 0.50 to 0.8 dL/g; 0.55 to 0.75 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or about 0.65 dL/g.

In certain embodiments, the Tg of the copolyester can be chosen from one of the following ranges: 85 to 100° C.; 86 to 99° C.; 87 to 98° C.; 88 to 97° C.; 89 to 96 ° C.; 90 to 95° C.; 91 to 95° C.; 92 to 94 ° C.

In another embodiment, the copolyester comprises diol residues comprising 30 to 42 mole percent TMCD residues and 58 to 70 mole percent EG residues. In one embodiment, the copolyester comprises diol residues comprising 33 to 38 mole percent TMCD residues and 62 to 67 mole percent EG residues.

In embodiments, the copolyester comprises: a) a dicarboxylic acid component comprising: (i) 90 to 100 mole% terephthalic acid residues; and (ii) about 0 to about 10 mole % of aromatic and/or aliphatic dicarboxylic acid residues having up to 20 carbon atoms; and (b) a glycol component comprising: (i) about 30 to about 42 mole % 2,2,4,4-tetramethyl-1,3-cyclobutanediol (TMCD) residues; and (ii) about 70 to about 58 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.70 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component comprises: (i) about 32 to about 42 mole % 2,2,4,4-tetramethyl-1,3-cyclobutanediol (TMCD) residues, and (ii) about 68 to about 58 mole % ethylene glycol residues; or (i) about 34 to about 40 mole % 2,2,4,4-tetramethyl-1,3-cyclobutanediol (TMCD) residues, and (ii) about 66 to about 60 mole % ethylene glycol residues; or (i) greater than 34 to about 40 mole % 2,2,4,4-tetramethyl-1,3-cyclobutanediol (TMCD) residues, and (ii) less than 66 to about 60 mole % ethylene glycol residues; or (i) 34.2 to about 40 mole % 2,2,4,4-tetramethyl-1,3-cyclobutanediol (TMCD) residues, and (ii) 65.8 to about 60 mole % ethylene glycol residues; or (i) about 35 to about 39 mole % 2,2,4,4-tetramethyl-1,3-cyclobutanediol (TMCD) residues, and (ii) about 65 to about 61 mole % ethylene glycol residues; or (i) about 36 to about 37 mole % 2,2,4,4-tetramethyl-1,3-cyclobutanediol (TMCD) residues; and (ii) about 64 to about 63 mole % ethylene glycol residues.

In one embodiment, the r-polyester is a copolyester comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising:
   (i) about 30 to about 42 mole % 2,2,4,4-tetramethyl-1,3-cyclobutanediol residues; and
   (ii) about 70 to about 58 mole % ethylene glycol residues, and less than about 5 mole %, or less than 2 mole %, of any other modifying glycols;
      wherein the total mole % of the dicarboxylic acid component is 100 mole %, and
      wherein the total mole % of the glycol component is 100 mole %; and
      wherein the inherent viscosity of the polyester is from 0.50 to 0.70 dL/g as determined in 60/40 (wt/wt) phenol/tetrachloroethane at a concentration of 0.25 g/50 ml at 25° C.

In embodiments, the copolyester has at least one of the following properties chosen from: a T_{g} of from about 100 to about 110° C. as measured by a TA 2100 Thermal Analyst Instrument at a scan rate of 20° C./min, a flexural modulus at 23° C. of equal to or greater than 2000 MPa (about 290,000 psi), or greater than 2200 MPa (319,000 psi) as defined by ASTM D790, a notched Izod impact strength of about 30 J/m (0.56 ft-lb/in) to about 80 J/m (1.50 ft-lb/in) according to ASTM D256 with a 10-mil notch using a 1/8-inch thick bar at 23° C., and less than 5% loss in inherent viscosity after being held at a temperature of 293° C. (560° F.) for 2 minutes. In one embodiment, the L* color values for the polyester composition is 90 or greater, or greater than 90, as determined by the L*a*b* color system measured following ASTM D 6290-98 and ASTM E308-99, performed on polymer granules ground to pass a 1 mm sieve.

In one embodiment, the copolyester comprises a diol component having at least 30 mole percent TMCD residues (based on the diols) and a catalyst/stabilizer component comprising: (i) titanium atoms in the range of 10-60 ppm based on polymer weight, (ii) manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In embodiments, the glycol component for the copolyesters includes but is not limited to at least one of the following combinations of ranges: about 30 to about 42 mole % 2,2,4,4-tetramethyl-1,3-cyclobutanediol and about 58 to 70 mole % ethylene glycol; about 32 to about 42 mole % 2,2,4,4-tetramethyl-1,3-cyclobutanediol and about 58 to 68 mole % ethylene glycol; about 32 to about 38 mole % 2,2,4,4-tetramethyl-1,3-cyclobutanediol and about 64 to 68 mole % ethylene glycol; about 33 to about 41 mole % 2,2,4,4-tetramethyl-1,3-cyclobutanediol and about 59 to 67 mole % ethylene glycol; about 34 to about 40 mole % 2,2,4,4-tetramethyl-1,3-cyclobutanediol and about 60 to 66 mole % ethylene glycol; greater than 34 to about 40 mole % 2,2,4,4-tetramethyl-1,3-cyclobutanediol and 60 to less than 66 mole % ethylene glycol; 34.2 to 40 mole % 2,2,4,4-tetramethyl-1,3-cyclobutanediol and about 60 to 65.8 mole % ethylene glycol; about 35 to about 39 mole % 2,2,4,4-tetramethyl-1,3-cyclobutanediol and about 61 to 65 mole % ethylene glycol; about 35 to about 38 mole % 2,2,4,4-tetramethyl-1,3-cyclobutanediol and about 62 to 65 mole % ethylene glycol; or about 36 to about 37 mole % 2,2,4,4-tetramethyl-1,3-cyclobutanediol and about 63 to 64 mole % ethylene glycol.

In certain embodiments, the r-polyesters may exhibit at least one of the following inherent viscosities as determined in 60/40 (wt/wt) phenol/tetrachloroethane at a concentration of 0.25 g/50 ml at 25° C. from 0.50 to 0.70 dL/g; 0.55 to 0.65 dL/g; 0.56 to 0.64 dL/g; 0.56 to 0.63 dL/g; 0.56 to 0.62 dL/g; 0.56 to 0.61 dL/g; 0.57 to 0.64 dL/g; 0.58 to 0.64 dL/g; 0.57 to 0.63 dL/g; 0.57 to 0.62 dL/g; 0.57 to 0.61 dL/g; 0.58 to 0.60 dL/g or about 0.59 dL/g.

In certain of the embodiments, for copolyesters comprising TMCD and EG residues, such copolyesters can contain less than 10 mole%, or less than 5 mole%, or less than 4 mole%, or less than 3 mole%, or less than 2 mole%, or less than 1 mole%, or no, CHDM residues.

Additional embodiments applicable to any or all of the embodiments disclosed herein:

In embodiments, the r-polyesters can be made from monomers that contain no 1,3-propanediol, or 1,4-butanediol, either singly or in combination. In other aspects, 1,3-propanediol or 1,4-butanediol, either singly or in combination, may be used in the making of the polyesters useful in this invention.

In embodiments, the mole % of cis-2,2,4,4-tetramethyl-1,3-cyclobutanediol in certain polyesters is greater than 50 mole % or greater than 55 mole % of cis-2,2,4,4-tetramethyl-1,3-cyclobutanediol or greater than 70 mole % of cis-2,2,4,4-tetramethyl-1,3-cyclobutanediol; wherein the total mole percentage of cis-2,2,4,4-tetramethyl-1,3-cyclobutanediol and trans-2,2,4,4-tetramethyl-1,3-cyclobutanediol is equal to a total of 100 mole %.

In embodiments, the mole % of the isomers of 2,2,4,4-tetramethyl-1,3-cyclobutanediol in certain polyesters is from 30 to 70 mole % of cis-2,2,4,4-tetramethyl-1,3-cyclobutanediol or from 30 to 70 mole % of trans-2,2,4,4-tetramethyl-1,3-cyclobutanediol, or from 40 to 60 mole % of cis-2,2,4,4-tetramethyl-1,3-cyclobutanediol or from 40 to 60 mole % of trans-2,2,4,4-tetramethyl-1,3-cyclobutanediol, wherein the total mole percentage of cis-2,2,4,4-tetramethyl-1,3-cyclobutanediol and trans-2,2,4,4-tetramethyl-1,3-cyclobutanediol is equal to a total of 100 mole %.

In certain embodiments, the r-polyesters can be amorphous or semi-crystalline. In one aspect, certain polyesters can have a relatively low crystallinity. Certain r-polyesters can thus have a substantially amorphous morphology, meaning that the polyesters comprise substantially unordered regions of polymer.

In embodiments, the r-polyester(s) and/or r-polyester composition(s) can have a unique combination of two or more physical properties such as high impact strengths, moderate to high glass transition temperatures, chemical resistance, hydrolytic stability, toughness, low ductile-to-brittle transition temperatures, good color and clarity, low densities, long crystallization half-times, and good processability thereby easily permitting them to be formed into articles. In some of the embodiments, the polyesters can have a unique combination of the properties of good impact strength, heat resistance, chemical resistance, density and/or the combination of the properties of good impact strength, heat resistance, and processability and/or the combination of two or more of the described properties.

In embodiments, the r-polyesters can be prepared from dicarboxylic acids and diols which react in substantially equal proportions and are incorporated into the polyester polymer as their corresponding residues. The polyesters, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

In embodiments, the Tg of the r-polyesters can be at least one of the following ranges: 100 to 200° C.; 100 to 190° C.; 100 to 180° C.; 100 to 170° C.; 100 to 160° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 200° C.; 105 to 190° C.; 105 to 180° C.; 105 to 170° C.; 105 to 160° C.; 105 to 155° C.; 105 to 150° C.; 105 to 145° C.; 105 to 140° C.; 105 to 138° C.; 105 to 135° C.; 105 to 130° C.; 105 to 125° C.; 105 to 120° C.; 105 to 115° C.; 105 to 110° C. greater than 105 to 125° C.; greater than 105 to 120° C.; greater than 105 to 115° C.; greater than 105 to 110° C.; 110 to 200° C.; 110 to 190° C.; 110 to 180° C.; 110 to 170° C.; 110 to 160° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115to 200° C.; 115 to 190° C.; 115 to 180° C.; 115 to 170° C.; 115 to 160° C.; 115to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127 to 180° C.; 127 to 170° C.; 127 to 160° C.; 127 to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; 150 to 200° C.; 150 to 190° C.; 150 to 180° C.; 150 to 170° C.; 150 to 160; 155 to 190° C.; 155 to 180° C.; 155 to 170° C.; and 155 to 165° C.

For certain embodiments, the r-polyesters may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the r-polyesters may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dug to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98dL/g; greater than 0.80 dL/g to 0.95 dL/g; greater than 0.80 dL/g to 0.90 dL/g.

In certain embodiments, it is contemplated that the r-polyesters or r-polyester compositions can possess at least one of the inherent viscosity ranges described herein and at least one of the monomer ranges for the compositions described herein unless otherwise stated. It is also contemplated that the r-polyesters or r-polyester compositions can possess at least one of the Tg ranges described herein and at least one of the monomer ranges for the compositions described herein unless otherwise stated. It is also contemplated that the r-polyesters or r-polyester compositions can possess at least one of the Tg ranges described herein, at least one of the inherent viscosity ranges described herein, and at least one of the monomer ranges for the compositions described herein unless otherwise stated.

In embodiments, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexandimethanol can vary within the range of 50/50 to 0/100, such as between 40/60 to 20/80.

In certain embodiments, terephthalic acid or an ester thereof, such as, for example, dimethyl terephthalate, or a mixture of terephthalic acid and an ester thereof, makes up most, or all, of the dicarboxylic acid component used to form the polyesters. In certain embodiments, terephthalic acid residues can make up a portion or all of the dicarboxylic acid component used to form the polyester at a concentration of at least 70 mole %, such as at least 80 mole %, at least 90 mole %, at least 95 mole %, at least 99 mole %, or 100 mole %. In certain embodiments, higher amounts of terephthalic acid can be used to produce a higher impact strength polyester. In one embodiment, dimethyl terephthalate is part or all of the dicarboxylic acid component used to make the polyesters useful in the present invention. For the purposes of this disclosure, reference to residues of “terephthalic acid” and “dimethyl terephthalate” are used interchangeably herein. For example, reference to polymer residues of terephthalic acid (TPA) also includes polymer residues derived from dimethyl terephthalate (DMT). In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, in certain embodiments the dicarboxylic acid component of the r-polyester can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used include but are not limited to those having up to 20 carbon atoms, and which can be linear, para-oriented, or symmetrical. Examples of modifying aromatic dicarboxylic acids which may be used include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

In embodiments, the carboxylic acid component of the r-polyesters can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In embodiments for r-polyesters containing CHDM, the 1,4-cyclohexanedimethanol may be cis, trans, or a mixture thereof, for example a cis/trans ratio of 60:40 to 40:60. In one embodiment, the trans-1,4-cyclohexanedimethanol can be present in an amount of 60 to 80 mole %.

In embodiments, the r-polyester(s) can be linear or branched. In embodiments, the polycarbonate (if included) can also be linear or branched. In certain embodiments, a branching monomer or agent may be added prior to and/or during and/or after the polymerization of the polycarbonate.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is hereby expressly incorporated herein by reference.

The glass transition temperature (Tg) of the polyesters can be determined using a TA DSC 2920 from Thermal Analyst Instrument at a scan rate of 20° C./min.

Long crystallization half-times (e.g., greater than 5 minutes) at 170° C. exhibited by certain of the polyesters, can be beneficial for production of certain injection molded, compression molded, and solution casted articles. The polyesters can be amorphous or semi-crystalline. In one aspect, certain polyesters can have relatively low crystallinity. Certain polyesters can thus have a substantially amorphous morphology, meaning that the polyesters comprise substantially unordered regions of polymer.

In one embodiment, an “amorphous” r-polyester can have a crystallization half-time of greater than 5 minutes at 170° C. or greater than 10 minutes at 170° C. or greater than 50 minutes at 170° C. or greater than 100 minutes at 170° C. In one embodiment, of the invention, the crystallization half-times are greater than 1,000 minutes at 170° C. In another embodiment of the invention, the crystallization half-times of the polyesters useful in the invention are greater than 10,000 minutes at 170° C. The crystallization half time of the polyester, as used herein, may be measured using methods well-known to persons of skill in the art. For example, the crystallization half time of the polyester, t_{1/2}, can be determined by measuring the light transmission of a sample via a laser and photo detector as a function of time on a temperature controlled hot stage. This measurement can be done by exposing the polymers to a temperature, Tₘₐₓ, and then cooling it to the desired temperature. The sample can then be held at the desired temperature by a hot stage while transmission measurements are made as a function of time. Initially, the sample can be visually clear with high light transmission and becomes opaque as the sample crystallizes. The crystallization half-time is the time at which the light transmission is halfway between the initial transmission and the final transmission. Tₘₐₓ is defined as the temperature required to melt the crystalline domains of the sample (if crystalline domains are present). The sample can be heated to Tₘₐₓ to condition the sample prior to crystallization half time measurement. The absolute Tₘₐₓ temperature is different for each composition. For example, PCT can be heated to some temperature greater than 290° C. to melt the crystalline domains.

In embodiments, certain r-polyesters are visually clear. The term “visually clear” is defined herein as an appreciable absence of cloudiness, haziness, and/or muddiness, when inspected visually. In one embodiment, when the r-polyesters are blended with polycarbonate, including bisphenol A polycarbonates to form a r-polyester composition, the blends can be visually clear. In embodiments, the polyesters can possess one or more of the properties described herein. In embodiments, the polyesters can have a yellowness index (ASTM D-1925) of less than 50, such as less than 20.

In embodiments, the r-polyesters and/or the r-polyester compositions of the invention, with or without toners, can have color values L*, a* and b*, which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them They are determined by the L*a*b* color system of the CIE (International Commission on Illumination) (translated), wherein L* represents the lightness coordinate, a* represents the red/green coordinate, and b* represents the yellow/blue coordinate. In certain embodiments, the b* values for the polyesters useful in the invention can be from −10 to less than 10 and the L* values can be from 50 to 90. In other embodiments, the b* values for the polyesters useful in the invention can be present in one of the following ranges: −10 to 9; −10 to 8; −10 to 7; −10 to 6; −10 to 5; −10 to 4; −10 to 3; −10 to 2; from −5 to 9; −5 to 8; −5 to 7; −5 to 6; −5 to 5; −5 to 4; −5 to 3; −5 to 2; 0 to 9; 0 to 8; 0 to 7; 0 to 6; 0 to 5; 0 to 4; 0 to 3; 0 to 2; 1 to 10; 1 to 9; 1 to 8; 1 to 7; 1 to 6; 1 to 5; 1 to 4; 1 to 3; and 1 to 2. In other embodiments, the L* value for the polyesters useful in the invention can be present in one of the following ranges: 50 to 60; 50 to 70; 50 to 80; 50 to 90; 60 to 70; 60 to 80; 60 to 90; 70 to 80; 79 to 90.

The r-polyester component of the r-polyester compositions can be made by processes known from the literature such as, for example, by processes in homogenous solution, by transesterification processes in the melt, and by two phase interfacial processes. Suitable methods include those disclosed in U.S. Published Application 2006/0287484, the contents of which is incorporated herein by reference. In one or more embodiments, the recycle content polyester or the r-polyester composition of the present invention may be characterized by one or more of the properties or property ranges set forth herein.

In embodiments, the r-polyester can be prepared by a method that includes reacting one or more dicarboxylic acids (or derivative thereof) with one or more glycols under conditions to provide the polyester including, but are not limited to, the steps of reacting one or more dicarboxylic acids (or derivative thereof) with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In embodiments, the r-polyester composition can be a polymer blend, wherein the blend comprises: (a) 5 to 95 wt % of at least one of the r-polyesters described herein; and (b) 5 to 95 wt % of at least one polymeric component. Suitable examples of polymeric components include, but are not limited to, nylon, polyesters different from those described herein, polyamides such as ZYTEL® from DuPont; polystyrene, polystyrene copolymers, styrene acrylonitrile copolymers, acrylonitrile butadiene styrene copolymers, poly(methylmethacrylate), acrylic copolymers, poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the other foregoing polymers. The blends can be prepared by conventional processing techniques known in the art, such as melt blending or solution blending. In one embodiment, the polycarbonate is not present in the polyester composition. If polycarbonate is used in a blend in the polyester compositions useful in the invention, the blends can be visually clear. However, the polyester compositions useful in the invention also contemplate the exclusion of polycarbonate as well as the inclusion of polycarbonate.

In addition, the r-polyester compositions and the polymer blend compositions may also contain from 0.01 to 25% by weight of the overall composition common additives such as colorants, dyes, mold release agents, flame retardants, plasticizers, nucleating agents, stabilizers, including but not limited to, UV stabilizers, thermal stabilizers and/or reaction products thereof, fillers, and impact modifiers. For example, UV additives can be incorporated into the articles (e.g., ophthalmic product(s)) through addition to the bulk or in the hard coat. Examples of typical commercially available impact modifiers well known in the art and useful in this invention include, but are not limited to, ethylene/propylene terpolymers; functionalized polyolefins, such as those containing methyl acrylate and/or glycidyl methacrylate; styrene-based block copolymeric impact modifiers, and various acrylic core/shell type impact modifiers. Residues of such additives are also contemplated as part of the polyester composition.

In embodiments, the r-polyester compositions can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally from 0.1 percent by weight to 10 percent by weight, such as from 0.1 to 5 percent by weight, based on the total weight of the polyester.

Thermal stabilizers are compounds that stabilize polyesters during polyester manufacture and/or post polymerization, including, but not limited to, phosphorous compounds, including, but not limited to, phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive. In embodiments, these can be present in the polyester compositions.

In embodiments, reinforcing materials may be useful in the r-polyester compositions or in the r-CE compositions described elsewhere herein. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

In one or more embodiments, the polymer with recycle content is a recycle content cellulose ester (or recycle content CE or r-cellulose ester or r-CE). The cellulose ester may be any that is known in the art. Cellulose esters useful in the present invention generally comprise repeating units of the structure:

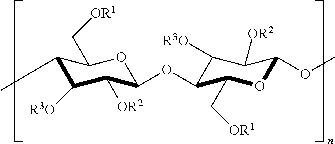

wherein R¹, R², and R³ are selected independently from the group consisting of hydrogen or straight chain alkanoyl having from 2 to 10 carbon atoms. For cellulose esters, the substitution level is typically expressed in terms of degree of substitution (DS), which is the average number of non-OH substitutents per anhydroglucose unit (AGU). Generally, conventional cellulose contains three hydroxyl groups in each AGU unit that can be substituted; therefore, DS can have a value between zero and three. However, low molecular weight cellulose mixed esters can have a total degree of substitution slightly above 3 due to end group contributions. Native cellulose is a large polysaccharide with a degree of polymerization from 250-5,000 even after pulping and purification, and thus the assumption that the maximum DS is 3.0 is approximately correct. However, as the degree of polymerization is lowered, as in low molecular weight cellulose mixed esters, the end groups of the polysaccharide backbone become relatively more significant, thereby resulting in a DS that can range in excess of 3.0. Relatively lower molecular weight cellulose mixed esters are discussed in more detail subsequently in this disclosure. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl, acetyl, butyryl, or propionyl. In one or more embodiments, the recycle content cellulose ester or the r-CE composition of the present invention may be characterized by one or more of the properties or property ranges set forth herein.

In embodiments of the invention, the r-cellulose esters have at least 2 anhydroglucose rings and can have between at least 50 and up to 5,000 anhydroglucose rings. The number of anhydroglucose units per molecule is defined as the degree of polymerization (DP) of the cellulose ester. In embodiments, n is in a range from 20 to 2,500, or 25 to 2,000, or 25 to 1,000, or 50 to 500, or 50 to 250. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. Examples of cellulose esters include, but are not limited to, cellulose acetate, cellulose diacetate, cellulose propionate, cellulose butyrate, cellulose acetate propionate (CAP), cellulose acetate butyrate (CAB), cellulose propionate butyrate, and the like. In embodiments, cellulose esters useful herein can have a DS/AGU of about 2 to about 2.99, and the substituting ester can comprise acetyl, propionyl, butyryl, or any combinations of these. In another embodiment of the invention, the total DS/AGU ranges from about 2 to about 2.99 and the DS/AGU of acetyl ranges from about 0 to 2.2, with the remainder of the ester groups comprising propionyl, butyryl or combinations thereof.

In one or more embodiments, the r-cellulose ester can be a cellulose triester or a secondary cellulose ester. Examples of cellulose triesters include, but are not limited to, cellulose triacetate, cellulose tripropionate, and cellulose tributyrate. Examples of secondary cellulose esters include cellulose acetate, cellulose acetate propionate, and cellulose acetate butyrate.

In one or more embodiments, the r-cellulose ester can be chosen from cellulose acetate (CA), cellulose propionate (CP), cellulose butyrate (CB), cellulose acetate propionate (CAP), cellulose acetate butyrate (CAB), cellulose propionate butyrate (CPB), and the like, or combinations thereof. Examples of such cellulose esters are described in U.S. Pat. Nos. 1,698,049; 1,683,347; 1,880,808; 1,880,560; 1,984,147, 2,129,052; and 3,617,201, and contents and disclosure of which are hereby incorporated by reference. Cellulose esters are generally known in the art and are for example manufactured and/or sold by the assignee of the present invention.

In one or more embodiments, the secondary cellulose esters useful in the present invention have an absolute weight average molecular weight (Mw) from about 5,000 to about 400,000 as measured by gel permeation chromatography (GPC) according to ASTM D6474. The following method is used to calculate the absolute weight average molecular weight values (Mw) for CE. The solvent is THF stabilized with BHT Preservative. The instrumentation for the THF/cellulose ester procedure consists of the following Agilent 1200 series components: degasser, isocratic pump, auto-sampler, column oven, UV/Vis detector and a refractive index detector. The test temperature is 30° C. and flow rate is 1.0 ml/min. A sample solution of 25 mg cellulose ester in 10 ml THF with BHT preservative and 10 pl toluene flow rate marker is made. The injection volume is 50 pl. The column set is Polymer Laboratories 5 μm PLgel, Guard+Mixed C+Oligopore. The detection is by refractive index. The calibrants are monodisperse polystyrene standards, Mw=580 to 3,220,000 from Polymer Laboratories. The universal calibration parameters are as follows: PS (K=0.0001280 and a=0.7120) and CE (K=0.00007572 and a=0.8424). The universal calibration parameters above were determined by light scattering and viscometery to yield the correct weight average molecular weights. In a further embodiment, the Mw is from about 15,000 to about 300,000. In yet further embodiments, the Mw ranges from about 10,000 to about 250,000; from about 15000 to 200000; from about 20,000 to about 150,000; from about 50,000 to about 150,000, or from about 70,000 to about 120,000.

The r-cellulose esters, which include cellulose acetate, cellulose diacetate, cellulose triacetate, cellulose acetate propionate, and cellulose acetate butyrate, can be formulated with additional ingredients, components such as additives, fillers and the like, to provide r-cellulose ester compositions. Examples of additives include plasticizers, waxes, compatibilizers, biodegradation promoters, dyes, pigments, colorants, luster control agents, lubricants, anti-oxidants, viscosity modifiers, antifungal agents, anti-fogging agents, heat stabilizers, impact modifiers, flame retardants, corrosion inhibitors, antibacterial agents, softening agents, fragrances, and mold release agents. In one or more embodiments, the r-cellulose ester compositions further include components or ingredients with recycle content. In a non-limiting example, the r-cellulose ester composition may further include a plasticizer with recycle content such as recycle content triacetin.

In one or more embodiments, the polymer with recycle content includes polymer that is formed from a feedstock that includes monomer or upstream monomer reactants or other feedstock materials formed from a depolymerization process. One of ordinary skill will be appreciate that the choice of useful depolymerization process, as well as the details and systems for that process, are influenced by a number of factors including for example the composition details and component identity of the depolymerization process feed.

In one or more embodiments, for example in embodiments wherein the polymer with recycle content is a recycle content polyester, the depolymerization process may be a methanolysis process or may be a glycolysis process. In methanolysis, the polyester is reacted with methanol to produce a depolymerized polyester mixture comprising polyester oligomers, dimethyl terephthalate (“DMT”), and a glycol, e.g., ethylene glycol (“EG”). Other monomers such as, for example, 1,4-cyclohexanedimethanol (“CHDM”) and diethylene glycol may also be produced depending on the composition of the polyester in the methanolysis feed stream. Representative methods for the methanolysis of PET for example are described in U.S. Pat. Nos. 3,037,050; 3,321,510; 3,776,945; 5,051,528; 5,298,530; 5,414,022; 5,432,203; 5,576,456 and 6,262,294, the contents and disclosure of which are incorporated herein by reference. A representative methanolysis process is also illustrated in U.S. Pat. No. 5,298,530, the contents and disclosure of which are incorporated herein by reference.

Glycolysis is another method of depolymerizing polyesters. A typical glycolysis process can be illustrated with particular reference to the glycolysis of PET, in which waste PET is dissolved in and reacted with a glycol, typically ethylene glycol, to form a mixture of dihydroxyethyl terephthalate and low molecular weight terephthalate oligomers. This mixture can be subjected to a transesterification reaction, usually in the presence of a ester exchange catalyst, with a lower alcohol, i.e., methanol to form dimethyl terephthalate and ethylene glycol, and other monomers, again depending upon the composition of the waste or scrap polyester feedstock. The DMT and ethylene glycol can be recovered and purified by distillation or a combination of crystallization and distillation. Some representative examples of glycolysis methods are disclosed in U.S. Pat. Nos. 3,257,335; 3,907,868; 6,706,843; and 7,462,649, the contents and disclosure of which are hereby incorporated herein by reference. Processes for the preparation of polyesters with high recycle content are also described in U.S. Published Patent Application No. 2013/0041053, assigned to the assignee of the present invention, the contents and disclosure of which are hereby incorporated herein by reference.

In one or more embodiments wherein the polymer with recycle content comprises a recycle content cellulose ester, the depolymerization process may include a recycle content syngas formation process, such process including the formation of a recycle content syngas which, in one or more embodiments may be an r-CE content syngas. In embodiments, the recycle content syngas can be provided by a process for the production of syngas comprising: (i) charging an oxidant and a feedstock composition to a gasification zone within a gasifier, said feedstock composition comprising waste plastic and in one or more embodiments a solid fossil fuel; (ii) gasifying the feedstock composition together with the oxidant in a gasification zone to produce a syngas composition; and discharging at least a portion of the syngas composition from the gasifier; wherein the gasifier is in one or more embodiments an entrained flow gasifier. In embodiments, the feedstock composition (to produce a recycle content syngas) can include any of the depolymerization feeds discussed herein.

In one or more embodiments, the feedstock composition comprises a solid fossil fuel and up to 25 wt. %, or up to 20 wt. %, or up 15 wt. %, or up to 12 wt. %, or up to 10 wt. %, or up to 7 wt. %, or up to 5 wt. %, or less than 5 wt. % waste plastic based on the total weight of the composition. In one or more embodiments, the feedstock composition comprises a solid fossil fuel and up to 25 wt. %, or up to 20 wt. %, or up 15 wt. %, or up to 12 wt. %, or up to 10 wt. %, or up to 7 wt. %, or up to 5 wt. %, or less than 5 wt. % reclaimable plastic waste or reclaimed plastic waste.

In one or more embodiments, the waste plastics may have a particle size in the largest dimension of not more than 2 mm.

In embodiments, the recycled content syngas can be a recycled CE content syngas provided by a process for the production of syngas comprising: (i) charging an oxidant and a feedstock composition to a gasification zone within a gasifier, said feedstock composition comprising waste cellulose ester plastic; (ii) gasifying the feedstock composition together with the oxidant in a gasification zone to produce a syngas composition; and discharging at least a portion of the syngas composition from the gasifier; wherein the gasifier is in one or more embodiments an entrained flow gasifier. In embodiments, the feedstock (to produce a recycled CE content syngas) comprises a solid fossil fuel and up to 25 wt. %, or up to 20 wt. %, or up 15 wt. %, or up to 12 wt. %, or up to 10 wt. %, or up to 7 wt. %, or up to 5 wt. %, or less than 5 wt. % waste cellulose ester plastic and other (optional) plastics based on the weights of solids in the feedstock composition.

Recycle content cellulose ester may be formed by method comprising the processing steps of: (1) preparing a recycled content syngas in a synthesis gas operation utilizing a feedstock that contains waste plastic and in embodiments a solid fossil fuel source, and in embodiments at least some content of recycled cellulose ester, and optionally other recycled plastics); (2) preparing at least one chemical intermediate from said syngas; (3) reacting said chemical intermediate in a reaction scheme to prepare at least one cellulose reactant for preparing a recycle CE, and/or selecting said chemical intermediate to be at least one cellulose reactant for preparing a recycle CE; and (4) reacting said at least one cellulose reactant to prepare said recycle CE; wherein said recycle CE comprises at least one substituent on an anhydroglucose unit (AGU) derived from recycled content syngas, e.g., recycled CE content syngas.

Recycled content syngas, recycled content CE syngas, recycle content cellulose esters and methods for their production are described for example in PCT Published Applications WO2020/242921; WO2021061918A1; WO2021092296A1 and U.S. Published Patent Application No. 2020/0247910, all assigned to the assignee of the present invention, all of which are hereby incorporated herein by reference.

In one or more embodiments, the recycle content cellulose ester may be a component of a recycle cellulose ester composition that may include at least one r-cellulose ester, at least one impact modifier, and optionally, at least one plasticizer. In embodiments of the invention, the impact modifier can be any material found to increase the impact strength of cellulose ester compositions. In one embodiment, the impact modifier can be any polymeric material classified as an elastomer with a glass transition temperature (Tg) below room temperature. Tg can be measured for example according to ASTM D3418 using a TA 2100 Thermal Analyst Instrument using a scan rate of 20° C./min. Several classes of impact modifier fit this description.

In one embodiment, the impact modifier can be selected from the class of materials known as modified polyolefins. In this class, the olefin is copolymerized with additional monomers that limit the crystallization of the polymer, increase the amount of the chain with Tg below room temperature, and reduce the modulus below 500 MPa. Examples of modified olefins include EMA, EBA, EVA, EEA, EPDM, and EPR.

In one class of the embodiment, the impact modifier is a block copolymer in which at least one segment of the chain has a Tg below room temperature, referred to as the soft segment, and at least one segment of the chain has a Tg or Tm above room temperature, referred to as the hard segment. These block copolymers are also commonly referred to as thermoplastic elastomers (TPEs). Examples of block copolymers of this class include styrenic materials such as SBS, SEBS, and SIS; thermoplastic urethanes (TPU); polyester-ether copolymers or polyamide-ether copolymers.

In one embodiment, the impact modifier can be selected from the class of emulsion-prepared materials known as core-shell impact modifiers. In one embodiment, the impact modifier is an MBS core-shell impact modifier such as a methacrylate-butadiene-styrene that has a core made out of butadiene-styrene copolymers and shell made out of methyl methacrylate-styrene copolymer. In another embodiment, the impact modifier is an acrylic core-shell impact modifier that has a core made from an acrylic polymer, such as butyl acrylate or styrene butyl acrylate, and shell from made from polymethylmethacrylate or styrene methylmethacryalate copolymer.

In one embodiment of the invention, the core shell impact modifier is an MBS impact modifier that can comprise: (A) from about 70 to about 85 parts of a core comprising from about 15 to about 35 percent by weight of units derived from at least one vinyl aromatic monomer, and from about 65 to about 85 percent by weight of units derived from at least one diolefin monomer; (B) from about 8 to about 14 parts of an inner graft stage comprising at least one vinyl aromatic monomer or at least one C1-C4 alkyl methacrylate monomer; (C) from about 0.1 to about 5 parts of an intermediate sealer stage comprising at least one monomer selected from a C1-C8 alkyl acrylate or a polyunsaturated crosslinker; and (D) from about 10 to about 16 parts of an outer shell comprising at least one C1-C4 alkyl (meth)acrylate monomers or at least one vinyl aromatic monomer.

In embodiments, the MBS impact modifier can comprise graft polymer compositions comprising 10 to 70 percent by weight of a polymer or a copolymer of butadiene and grafts of firstly methyl(meth)acrylate and cross-linker, and secondly of styrene, and thirdly of methyl(meth)acrylate with an optional cross-linker.

Monomers suitable for polymerization with the conjugated diolefin and preferably with butadiene, can include alkenyl aromatic compounds and preferably vinyl aromatic compounds such as styrene, divinylbenzene, alpha-methyl styrene, vinyl toluene, hydrogenated styrene; lower (CZ-Cu) alkyl acrylates such as ethyl acrylate, n-propylacrylate, n-butyl acrylate, Z-methylbutylacrylate, 3-methylbutyl acrylate, amylacrylate, n-hexylacrylate, Z-ethylhexyl acrylate; lower (C2-C12) alkyl(meth)acrylates; acrylonitriles; olefins; and the like; or a combination of any of the foregoing.

Suitable cross-linking agents include divinylbenzene; di(meth)acrylates; diacrylates such as the diacrylate of mono-, di- or polyethylene glycol; their (meth)acrylates; divinyl sulfide; divinyl ether; vinyl acrylate; vinyl(meth)acrylate; trivinylbenzene; trimethylolpropane; tri(meth)acrylate; triallyl cyanurate and triallyl isocyanurate.

In one embodiment, the MBS core-shell impact modifier can comprise a copolymer of butadiene and styrene and most preferably a terpolymer of butadiene, styrene, and divinylbenzene. Although the relative amounts of the monomers which comprise the copolymeric substrate may vary, the butadiene component will typically comprise from about 30 to 100 parts by weight, the styrene component will comprise from 0 to about 70 parts by weight, and the divinylbenzene component will comprise from 0 to about 5 parts by weight based upon 100 parts by weight of butadiene, styrene, and divinylbenzene combined. In an embodiment, the copolymer substrate can comprise from about 50 to about 90 parts by weight of butadiene, from about 10 to about 50 parts by weight of styrene, and from 0 to about 5 parts by weight of divinylbenzene on the same basis, and most preferably, from about 65 to about 85 parts by weight of butadiene, from about 15 to about 35 parts by weight of styrene, and from about 0.5 to about 2.0 parts by weight of divinylbenzene on the same basis.

Examples of methacrylate-butadiene-styrene core shell polymers are those described in, but not limited to, patents U.S. Pat. Nos. 4,446,585, 5,534,594, and 6,331,580.

In one embodiment of the present invention, the core shell impact modifier is an acrylic impact modifier comprising about 25 to 95 weight percent of a first elastomeric phase polymerized from a monomer system comprising about 75 to 99.8 percent by weight of a (C1 to C6) alkyl acrylate, 0.1 to 5 percent by weight cross-linking monomer, and 0.1 to 5 percent by weight graft linking monomer, and about 75 to 5 weight percent of a final, rigid thermoplastic phase free of epoxy groups polymerized in the presence of said elastomeric phase. Examples of useful acrylates are methyl acrylate, ethyl acrylate, butyl acrylate, 2-ethylhexyl acrylate and the like. In some embodiments, the acrylates are n-butyl acrylate and ethyl acrylate.

Graft linking monomer is defined as polyethylenically unsaturated monomer which has both a highly reactive double bond and a double bond of lower reactivity such that the highly reactive double bond tends to polymerize during the first stage monomer polymerization leaving a remaining double bond for polymerization during the next stage polymerization and thereby to graft link the first stage with the second stage polymers. In some embodiments, the graft linking monomers are allyl methacrylate, allyl acrylate and diallyl maleate. In an embodiment, 0.05 to 3 percent graft linking monomer is present based on first stage monomer systems. Cross linking monomer is also preferably present, generally in amounts of about 0.05 to 3 percent by weight based on first stage monomer system, and is defined as a polyethylenically unsaturated monomer having at least two double bonds of about equal reactivity so as to cause cross-linking in the first stage polymerization. Examples of typical cross-linking monomers are 1,3-butylene diacrylate, 1,3-butylene dimethacrylate, divinylbenzene and the like.

By “epoxy functionality” is meant the epoxy units which are pendant from the final stage polymer. In some embodiments, epoxy functionality is incorporated into the final stage polymer by use of epoxy containing monomer such as glycidyl acrylate or glycidyl methacrylate in the final stage monomer mixture.

Examples of acrylic core shell polymers are those described in, but not limited to, patents U.S. Pat. Nos. 3,448,173, 3,655,825, and 3,853,968. Examples of suitable acrylic impact modifiers are Kane Ace ECO100 or M570 from Kaneka.

In one class of this embodiment, the impact modifier is an ABS core-shell impact modifier that has a core made out of butadiene-styrene copolymers and shell made out of acrylonitrile-styrene copolymer. Examples of ABS core-shell impact modifiers include Blendex from Galata Chemicals and Elix from Elix Polymers.

In one class of this embodiment, the impact modifier is a silicone-acrylic core-shell impact modifier that has a core made out of silicone-acrylic rubber and shell made out of PMMA copolymer or methyl methacrylate-styrene copolymer. Examples of silicone-acrylic core-shell impact modifiers include an Metablen S from Mitsubishi Chemical Company.

In one embodiment, the impact modifier has a relatively neutral pH (e.g., pH between 6 and 8, preferably between 6.5 and 7.5). In one embodiment, the cellulose ester and impact modifier composition is transparent, with light transmission of at least 70%, or at least 75%, or at least 80%, or at least 85%, or at least 90%, measured according to ASTM D1003 using a 3.2 mm plaque after injection molding at a barrel set point of 249° C. and a residence time of 5 min. In certain embodiments, the polymer-based resin has transmission in the range from 70% to 95%, or 75% to 95%, or 80% to 95%, or 85% to 95%, or 70% to 90%, or 75% to 90%, or 80% to 90%, or 85% to 90%, measured according to ASTM D1003 using a 3.2 mm plaque after injection molding at a barrel set point of 249° C. and a residence time of 5 min. In one class of this embodiment, the cellulose ester composition comprising the impact modifier has a percent haze of less than 10%. In embodiments, the cellulose ester composition comprising the impact modifier has a percent haze of less than 8%, or less than 6%, or less than 5%.

In another embodiment, the refractive index (RI) of the impact modifiers is sufficiently close to that of the r-cellulose esters to provide a composition with high transmission and low haze. In one embodiment, the acrylic impact modifiers have a RI that close to the RI of the cellulose ester of about 1.46-1.50 to provide clear compositions. In embodiments, the impact modifier and cellulose ester components have a difference in refractive index, RI(second component)-RI(first component) (e.g., RI of CE—RI of impact modifier), of about 0.006 to about −0.0006, and the immiscible blend has a percent transmittance of at least 75%, and a haze of 10% or less more preferably 5% or less.

In one embodiment, the impact modifier can be either a non-reactive impact modifier or a reactive impact modifier, or combination of both. The impact modifiers used can also improve mechanical and physical properties of the cellulose ester compositions.

In one embodiment, where non-reactive impact modifiers are utilized, the impact modifier contains a first polymeric chain segment that is more chemically or physically compatible with the cellulose ester than another polymeric chain segment. In an embodiment, the first segment contains polar functional groups, which provide compatibility with the cellulose ester, including, but not limited to, such polar functional groups as ethers, esters, amides, alcohols, amines, ketones and acetals. Compatibility is defined by the preferential interaction of the first polymer chain segment with the cellulose ester polymer relative to the second segment and can mean molecular scale or microscale interactions. The first segment may consist of oligomers or polymers of the following: cellulose esters; cellulose ethers; polyoxyalkylene, such as, polyoxyethylene, polyoxypropylene, polyoxybutylene; polyglycols, such as, polyethylene glycol, polypropylene glycol, polybutylene glycol; polyesters, such as, polycaprolactone, polylactic acid, aliphatic polyesters, aliphatic-aromatic copolyesters; polyacrylates and polymethacrylates; polyacetals; polyvinylpyrrolidone; polyethylenevinyl acetate; polyvinyl acetate; and polyvinyl alcohol. In one embodiment, the first segment is polyethylenevinyl acetate; polyoxyethylene or polyvinyl alcohol.

In embodiments, the second segment can be either saturated or unsaturated hydrocarbon groups or contain both saturated and unsaturated hydrocarbon groups. The second segment can be an oligomer or a polymer. In one embodiment of the invention, the second segment of the non-reactive impact modifier is selected from the group consisting of polyolefins, polydienes, polyaromatics, and copolymers. An example of a polyaromatic second segment is polystyrene. An example of a copolymer second segment is styrene/butadiene copolymer.

The first and second segments of the non-reactive impact modifiers can be in a diblock, triblock, branched or comb structure. The molecular weight of the non-reactive impact modifiers can range from about 300 to about 20,000 or from about 500 to about 10,000 or from about 1,000 to about 5,000. The segment ratio of the non-reactive impact modifiers can range from about 15 to about 85% polar first segments to about 15 to about 85% nonpolar second segments.

Examples of non-reactive impact modifiers include, but are not limited to, ethoxylated alcohols, ethoxylated alkylphenols, ethoxylated fatty acids, polyethylenevinyl acetate, block polymers of propylene oxide and ethylene oxide, ethylene/propylene terpolymers, functionalized polyolephins, polyglycerol esters, polysaccharide esters, and sorbitan esters. Examples of ethoxylated alcohols are C₁₁-C₁₅ secondary alcohol ethoxylates, polyoxyethylene cetyl ether, polyoxyethylene stearyl ether, and C₁₂-C₁₄ natural liner alcohol ethoxylated with ethylene oxide. C₁₁-C₁₅ secondary ethyoxylates can be obtained as Dow Tergitol® 15S from the Dow Chemical Company. Polyoxyethlene cetyl ether and polyoxyethylene stearyl ether can be obtained from ICI Surfactants under the Brij® series of products. C₁₂-C₁₄ natural linear alcohol ethoxylated with ethylene oxide can be obtained from Hoechst Celanese under the Genapol series of products. Examples of ethoxylated alkylphenols include octylphenoxy poly(ethyleneoxy)ethanol and nonylphenoxy poly(ethyleneoxy)ethanol. Octylphenoxy poly(ethyleneoxy)ethanol can be obtained as Igepal® CA series of products from Rhodia, and nonylphenoxy poly(ethyleneoxy)ethanol can be obtained as Igepal CO series of products from Rhodia or as Tergitol® NP from Dow Chemical Company. Ethyoxylated fatty acids can include polyethyleneglycol monostearate or monolaruate which can be obtained from Henkel under the Nopalcol® series of products. Block polymers of propylene oxide and ethylene oxide can be obtained under the Pluronic® series of products from BASF. Polyglycerol esters can be obtained from Stepan under the Drewpol® series of products. Polysaccharide esters can be obtained from Henkel under the Glucopon® series of products, which are alkyl polyglucosides. Sorbitan esters can be obtained from ICI under the Tween® series of products.

In another embodiment of the invention, the non-reactive impact modifiers can be synthesized in situ in the r-cellulose ester composition by reacting cellulose ester-compatible compounds. These compounds can be, for example, telechelic oligomers, which are defined as prepolymers capable of entering into further polymerization or other reaction through their reactive end groups. In one embodiment of the invention, these in situ impact modifiers can have higher molecular weight from about 10,000 to about 1,000,000.

In another embodiment of the invention, the impact modifier can be reactive. The reactive impact modifier can comprise a polymer or oligomer compatible with one component of the composition and functionality capable of reacting with another component of the composition. In embodiments, there are two types of reactive impact modifiers that can be used. The first reactive impact modifier has a hydrocarbon chain that is compatible with the cellulose ester and also has functionality capable of reacting with the cellulose ester. Such functional groups include, but are not limited to, carboxylic acids, anhydrides, acid chlorides, epoxides, and isocyanates. Specific examples of this type of reactive impact modifier include, but are not limited to: long chain fatty acids, such as, stearic acid (octadecanoic acid); long chain fatty acid chlorides, such as, stearoyl chloride (octadecanoyl chloride); long chain fatty acid anhydrides, such as, stearic anhydride (octadecanoic anhydride); epoxidized oils and fatty esters; styrene maleic anhydride copolymers; maleic anhydride grafted polypropylene; copolymers of maleic anhydride with olefins and/or acrylic esters, e.g. terpolymers of ethylene, acrylic ester and maleic anhydride; and copolymers of glycidyl methacrylate with olefins and/or acrylic esters, e.g. terpolymers of ethylene, acrylic ester, and glycidyl methacrylate.

Reactive impact modifiers can be obtained as SMA® 3000 styrene maleic anhydride copolymer from Sartomer/Cray Valley, Eastman G-3015® maleic anhydride grafted polypropylene from Eastman Chemical Company, Epolene® E-43 maleic anhydride grafted polypropylene obtained from Westlake Chemical, Lotader® MAH 8200 random terpolymer of ethylene, acrylic ester, and maleic anhydride obtained from Arkema, Lotader® GMA AX 8900 random terpolymer of ethylene, acrylic ester, and glycidyl methacrylate, and Lotarder® GMA AX 8840 random terpolymer of ethylene, acrylic ester, and glycidyl methacrylate.

The second type of reactive impact modifier has a polar chain that is compatible with the cellulose ester and also has functionality capable of reacting with the cellulose ester. Examples of these types of reactive impact modifiers include cellulose esters or polyethylene glycols with olefin or thiol functionality. Reactive polyethylene glycol impact modifiers with olefin functionality include, but are not limited to, polyethylene glycol allyl ether and polyethylene glycol acrylate. An example of a reactive polyethylene glycol impact modifier with thiol functionality includes polyethylene glycol thiol. An example of a reactive cellulose ester impact modifier includes mercaptoacetate cellulose ester.

In embodiments of the invention, the amount of impact modifier in the cellulose ester composition can range from about 1 wt % to about 30 wt %, or from about 1 wt % to about 15 wt %, or from about 5 wt % to about 10 wt %, or from about 10 wt % to about 30 wt %, or from about 15 wt % to about 30 wt %, based on the weight of the cellulose ester composition.

In one embodiment of the invention, the r-cellulose ester composition can contain a plasticizer. The plasticizer utilized in this invention can be any that is known in the art that can reduce the glass transition temperature and/or the melt viscosity of the cellulose ester to improve melt processing characteristics. The plasticizer may be any plasticizer suitable for use with a cellulose ester. The plasticizer level should be lower than the normal (or typical) plasticizer level for cellulose esters; so that the compositions have higher Tg (or HDT) than fully plasticized cellulose ester compositions, good toughness and good flow. In embodiments, the plasticizer is present in an amount that does not substantially reduce the Tg (or HDT) of the r-cellulose ester composition compared to a similar composition without the plasticizer. In embodiments, the Tg (or HDT) does not change (e.g., reduce) more than 20%, or 15%, or 10%, or 5%, or 2%, as a result of including the plasticizer.

The plasticizer can be either monomeric or polymeric in structure. In one embodiment, the plasticizer is at least one selected from the group consisting of an aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic trimester plasticizer, aliphatic diester plasticizer, carbonate plasticizer, epoxidized ester plasticizer, epoxidized oil plasticizer, benzoate plasticizer, polyol benzoate plasticizer adipate plasticizer, a phthalate plasticizer, a glycolic acid ester plasticizer, a citric acid ester plasticizer, a hydroxyl-functional plasticizer, or a solid, non-crystalline resin plasticizer.

In one embodiment of the invention, the plasticizer can be selected from at least one of the following: triphenyl phosphate, tricresyl phosphate, cresyldiphenyl phosphate, octyldiphenyl phosphate, diphenylbiphenyl phosphate, trioctyl phosphate, tributyl phosphate, diethyl phthalate, dimethoxyethyl phthalate, dimethyl phthalate, dioctyl phthalate, dibutyl phthalate, di-2-ethylhexyl phthalate, butylbenzyl phthalate, dibenzyl phthalate, butyl phthalyl butyl glycolate, ethyl phthalyl ethyl glycolate, methyl phthalyl ethyl glycolate, triethyl citrate, tri-n-butyl citrate, acetyltriethyl citrate, acetyl-tri-n-butyl citrate, and acetyl-tri-n-(2-ethylhexyl) citrate, diethylene glycol dibenzoate, dipropylene glycol dibenozoate, or triethylene glycol dibenzoate.

In another embodiment of the invention, the plasticizer can be selected from at least one of the following: esters comprising: (i) acid residues comprising one or more residues of: phthalic acid, adipic acid, trimellitic acid, succinic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms.

In another embodiment of the invention, the plasticizer can be selected from at least one of the following: esters comprising: (i) at least one acid residue selected from the group consisting of phthalic acid, adipic acid, trimellitic acid, succinic acid, benzoic acid, azelaic acid, terephthalic acid, isophthalic acid, butyric acid, glutaric acid, citric acid and phosphoric acid; and (ii) at least one alcohol residue selected from the group consisting of aliphatic, cycloaliphatic, and aromatic alcohol containing up to about 20 carbon atoms.

In another embodiment of the invention, the plasticizer can comprise alcohol residues where the alcohol residues is at least one selected from the following: stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol.

In another embodiment of the invention, the plasticizer can be selected from at least one of the following: benzoates, phthalates, phosphates, arylene-bis(diaryl phosphate), and isophthalates. In another embodiment, the plasticizer comprises diethylene glycol dibenzoate, abbreviated herein as “DEGDB”.

In another embodiment of the invention, the plasticizer can be selected from at least one of the following: aliphatic polyesters comprising C2-10 diacid residues, for example, malonic acid, succinic acid, glutaric acid, adipic acid, pimelic acid, suberic acid, azelaic acid, and sebacic acid; and C₂₋₁₀ diol residues.

In another embodiment, the plasticizer can comprise diol residues which can be residues of at least one of the following C₂-C10 diols: ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6 hexanediol, 1,5-pentylene glycol, triethylene glycol, and tetraethylene glycol.

In another embodiment, the plasticizer can include polyglycols, such as, for example, polyethylene glycol, polypropylene glycol, and polybutylene glycol. These can range from low molecular weight dimers and trimers to high molecular weight oligomers and polymers. In one embodiment, the molecular weight of the polyglycol can range from about 200 to about 2000.

In another embodiment, the plasticizer comprises at least one of the following: Resoflex® R296 plasticizer, Resoflex® 804 plastocizer, SHP (sorbitol hexapropionate), XPP(xylitol pentapropionate), XPA(xylitol pentaacetate), GPP(glucose pentaacetate), GPA (glucose pentapropionate) and APP (arabitol pentapropionate).

In another embodiment, the plasticizer comprises one or more of: A) from about 5 to about 95 weight % of a C2-C12 carbohydrate organic ester, wherein the carbohydrate comprises from about 1 to about 3 monosaccharide units; and B) from about 5 to about 95 weight % of a C2-C12 polyol ester, wherein the polyol is derived from a C5 or C6 carbohydrate. In one embodiment, the polyol ester does not comprise or contain a polyol acetate or polyol acetates.

In another embodiment, the plasticizer comprises at least one carbohydrate ester and the carbohydrate portion of the carbohydrate ester is derived from one or more compounds selected from the group consisting of glucose, galactose, mannose, xylose, arabinose, lactose, fructose, sorbose, sucrose, cellobiose, cellotriose and raffinose. In another embodiment, the plasticizer comprises at least one carbohydrate ester and the carbohydrate portion of the carbohydrate ester comprises one or more of α-glucose pentaacetate, β-glucose pentaacetate, α-glucose pentapropionate, β-glucose pentapropionate, α-glucose pentabutyrate and β-glucose pentabutyrate. In another embodiment, the plasticizer comprises at least one carbohydrate ester and the carbohydrate portion of the carbohydrate ester comprises an α-anomer, a β-anomer or a mixture thereof.

In another embodiment, the plasticizer can be selected from at least one of the following: propylene glycol dibenzoate, glyceryl tribenzoate, diethylene glycol dibenzoate, triethylene glycol dibenzoate, di propylene glycol dibenzoate, and polyethylene glycol dibenzoate.

In another embodiment, the plasticizer can be a solid, non-crystalline resin. These resins can contain some amount of aromatic or polar functionality and can lower the melt viscosity of the cellulose esters. In one embodiment of the invention, the plasticizer can be a solid, non-crystalline compound (resin), such as, for example, rosin; hydrogenated rosin; stabilized rosin, and their monofunctional alcohol esters or polyol esters; a modified rosin including, but not limited to, maleic- and phenol-modified rosins and their esters; terpene resins; phenol-modified terpene resins; coumarin-indene resins; phenolic resins; alkylphenol-acetylene resins; and phenol-formaldehyde resins.

In another embodiment, the plasticizer is at least one plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, di-octyl adipate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, triethylene glycol bis-2-ethyl hexanoate, glycerol esters, diethylene glycol, polypropylene glycol, polyglycoldiglycidyl ethers, dimethyl sulfoxide, N-methyl pyrollidinone, C1-C20 dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, diethylene glycol dibenzoate, dipropylene glycol dibenozoate, triethylene glycol dibenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

The amount of plasticizer in the r-cellulose ester composition can range from 0 to about 15 weight percent based on the weight of the cellulose ester composition. In one embodiment, the amount can range up to about 15 weight percent based on the weight of the cellulose ester composition. In another embodiment, the amount can range up to about 10 weight percent based on the weight of the cellulose ester composition. In another embodiment, the amount can range up to about 5 weight percent based on the weight of the cellulose ester composition, or up to about 3 weight percent based on the weight of the cellulose ester composition, or less than 2 weight percent based on the weight of the cellulose ester composition. In embodiments, the cellulose ester composition comprises a cellulose ester that is CAP and 0 to 5 wt %, or 0 to 4 wt %, or 0 to 3 wt %, or 0 to 2 wt %, or 0 to 1 wt % plasticizer. In another embodiment, the cellulose ester composition contains no plasticizer. In one embodiment, the cellulose ester composition comprises a cellulose ester that is CAP and no plasticizer.

In another embodiment, the r-cellulose ester composition is melt processable, i.e., suitable for thermal processing below their degradation temperature to obtain homogeneous pellets or plastic articles. For example, the compositions described can be melt extruded on a Werner & Pflerderer 30 mm twin screw extruder at a throughput of 35 lbs/hour with screw speed of 250 rpm and barrel temperature of 240° C. injection molded on a Toyo 110 injection molding machine with barrel temperature of 240° C. and mold temperature of 160° F. with minimal molecular weight or color degradation.

In one embodiment, a melt processable r-cellulose ester composition is provided comprising 1 to 30 wt %, or 1 to 15 wt %, or 2 to10 wt % of impact modifiers and no plasticizer, the cellulose ester composition having a heat deflection temperature (HDT) value of greater than 950 C (measured according to ASTM D648 at a 1.82 MPa stress level after conditioning for 4 hours at 700 C), and notched Izod impact strength value of greater than 80 J/m (measured according to ASTM D256 on 3.2 mm thick bars at 230 C), and spiral flow values of at least 15 inches at 2400 C when measured using the procedure described herein. In one embodiment, the cellulose ester composition has a Tg value measured at 200 C/min according to ASTM D3418 of greater than 120° C. Unless specified otherwise, Notched Izod Impact Strength was performed on molded bars after notching according to ASTM Method D256 after conditioning at 230 C and 50% RH for 48 hours, on 3.2 mm thick bars at 230 C.

In another embodiment, the compositions have a melt viscosity at 240° C. and 400 rad/s of 10,000 P or below measured by a plate-plate melt rheometer such as a Rheometrics Dynamic Analyzer (RDA II) with 25 mm diameter parallel plates, 1 mm gap and 10% strain measured in accordance with ASTM D4440 using frequency scan of between 1 rad/sec and 400 rad/sec.

In one embodiment, the melt processable cellulose ester compositions comprise 1 to 30 wt %, or 1 to 15 wt % of impact modifiers, 0 to 15 wt % of plasticizers, and have a Tg greater than 90° C. In another embodiment, the melt processable cellulose ester compositions comprise 1 to 30 wt %, or 1 to 15 wt % of impact modifiers, 0 to 10 wt % of plasticizers, and have a Tg greater than 100° C. In yet another embodiment, melt processable cellulose ester compositions comprise 1 to 10 wt % of impact modifiers, 0 to 10 wt % of plasticizers, and have a Tg greater than 100° C. In another embodiment, melt processable cellulose ester compositions comprise 1 to 10 wt % of impact modifiers, 0 to 5 wt % of plasticizers, and have a Tg greater than 115° C.

In embodiments, the r-cellulose ester is a polymer-based resin that has a heat distortion temperature (“HDT”) greater than 90° C., or greater than 95° C., according to ASTM D648 as measured at 1.82 MPa using a 3.2 mm thick bar that was subjected to 70 ° C. for 4 hours. In certain embodiments, the polymer-based resin has a heat distortion temperature (“HDT”) of at least 95° C., at least 100° C., at least 105° C., or at least 110° C., or at least 115° C. In certain embodiments, the polymer-based resin has a heat distortion temperature (“HDT”) in the range from 90° C. to 140° C., 90° C. to 130° C., 90° C. to 120° C., 90° C. to 110° C., 95° C. to 140° C., 95° C. to 130° C., 95° C. to 120° C., 95° C. to 110° C., 95° C. to 105° C., 100° C. to 140° C., 100° C. to 130° C., 100° C. to 120° C., 100° C. to 110° C., 105° C. to 140° C., 105° C. to 130° C., 105° C. to 120° C., 105° C. to 115° C., 105° C. to 110° C., 110° C. to 140° C., 110° C. to 130° C., 110° C. to 125° C., 110° C. to 120° C., 110° C. to 115° C., 115° C. to 140° C., 115° C. to 130° C., 120° C. to 140° C., 120° C. to 130° C., or 120° C. to 125° C.

In embodiments, the polymer-based resin has a notched izod impact strength of at least 80 J/m, or at least 90 J/m, or at least 100 J/m, or at least 110 J/m, or at least 120 J/m, or at least 130 J/m, or at least 140 J/m, or at least 150 J/m, or at least 160 J/m, or at least 170 J/m, or at least 180 J/m, or at least 190 J/m, or at least 200 J/m, as measured according to ASTM D256 using a 3.2 mm thick bar that has been subjected to 50% relative humidity for 48 hours at 23° C. In certain embodiments, the polymer-based resin has a notched izod impact strength in the range of from about 80 J/m to about 500 J/m, from about 80 J/m to about 400 J/m, from about 80 J/m to about 300 J/m, from about 80 J/m to about 200 J/m, from about 100 J/m to about 500 J/m, from about 100 J/m to about 400 J/m, from about 100 J/m to about 300 J/m, from about 100 J/m to about 200 J/m, from about 120 J/m to about 500 J/m, from about 120 J/m to about 400 J/m, from about 120 J/m to about 300 J/m, from about 120 J/m to about 200 J/m, from about 150 J/m to about 500 J/m, from about 150 J/m to about 400 J/m, from about 150 J/m to about 300 J/m, from about 150 J/m to about 200 J/m, from about 170 J/m to about 500 J/m, from about 170 J/m to about 400 J/m, from about 170 J/m to about 300 J/m, from about 170 J/m to about 200 J/m, from 180 J/m to about 500 J/m, from about 180 J/m to about 400 J/m, from about 180 J/m to about 300 J/m, from about 180 J/m to about 200 J/m, from 190 J/m to about 500 J/m, from about 190 J/m to about 400 J/m, from about 190 J/m to about 300 J/m, from about 190 J/m to about 200 J/m, from 200 J/m to about 500 J/m, from about 200 J/m to about 400 J/m, or from about 200 J/m to about 300 J/m, as measured according to ASTM D256 using a 3.2 mm thick bar that has been subjected to 50% relative humidity for 48 hours at 23° C.

In embodiments, the polymer-based resin has a flexural modulus of greater than 1800 MPa as measured according to ASTM D790 using a 3.2 mm thick bar hat has been subjected to 50% relative humidity for 48 hours at 23° C. In certain embodiments, the polymer-based resin has a flexural modulus of at least 1900 MPa, at least 2000 MPa, at least 2100 MPa, at least 2200 MPa, at least 2300MPa, or at least 2400 MPa, as measured according to ASTM D790 using a 3.2 mm thick bar hat has been subjected to 50% relative humidity for 48 hours at 23° C. In certain embodiments, the polymer-based resin has a flexural modulus is in the range of from about 1800 to about 3500 MPa, from about 1900 to about 3500 MPa, from about 2000 to about 3500 MPa, from about 2100 to about 3500 MPa, from about 2200 to about 3500 MPa, from about 2300 to about 3500 MPa, from about 2400 to about 3500 MPa, or from about 2500 to about 3500 MPa. as measured according to ASTM D790 using a 3.2 mm thick bar hat has been subjected to 50% relative humidity for 48 hours at 23° C. In certain embodiments, the polymer-based resin has a flexural modulus is in the range of from about 1900 to about 2500 MPa, from about 1900 to about 2800 MPa, or from about 1900 to about 3000 MPa, as measured according to ASTM D790 using a 3.2 mm thick bar hat has been subjected to 50% relative humidity for 48 hours at 23° C.

In certain embodiments, in addition to the impact modifier (discussed herein), the r-cellulose ester composition may include stabilizers selected from the group consisting of secondary antioxidants, acid scavengers, or a combination thereof. In certain embodiments, in addition to the impact modifier (discussed herein), the r-cellulose ester composition includes a secondary antioxidant in the range from about 0.1 to about 0.8 wt % based on the total weight of the composition. In certain embodiments, in addition to the impact modifier (discussed herein), the cellulose ester composition includes an acid scavenger in the range from about 0.2 to about 2.0 wt % based on the total weight of the composition. In one embodiment, in addition to the impact modifier (discussed herein), the cellulose ester composition includes a secondary antioxidant in the range from about 0.1 to about 0.8 wt % and an acid scavenger in the range from about 0.2 to about 2.0 wt % based on the total weight of the composition. In one embodiment, the secondary antioxidant is 3,9-bis(2,4-di-tert-butylphenoxy)-2,4,8,10-tetraoxa-3,9-diphosphaspiro[5.5]undecane. In one embodiment, the acid scavenger is an epoxidized fatty acid ester. In one embodiment, the r-cellulose ester composition further includes a salt stabilizer, for example in the range from about 0.1 to about 0.5 wt % based on the total weight of the composition. In one embodiment, other than the r-cellulose ester, impact modifier and stabilizers (discussed herein), the r-cellulose ester composition contains a total of less than 5 wt %, or less than 2 wt %, of any other components, based on the total weight of the composition.

In certain embodiments, the r-cellulose ester composition contains no maleic anhydride modified EVA, or no polyether ester compounds, or no adipic acid compounds. In certain embodiments, the cellulose ester composition comprises 65-99 wt % of one or more cellulose esters, 1-30 wt % of one or more impact modifiers, and less than 5 wt % total of other components, based on the total weight of the cellulose ester composition. In certain embodiments, such other components do not include plasticizers, polyether ester compounds or adipic acid compounds. In embodiments, the cellulose ester composition contains dioctyl adipate (DOA) plasticizer and no other adipic acid compounds.

While methanolysis, glycolysis and recycle content syngas formation are specifically referenced and described as depolymerization methods herein, it should be appreciated by one of ordinary skill that other depolymerization methods may be useful in forming the recycle monomer or the feedstock that includes monomer or upstream monomer reactants or other feed materials as described herein. For example, any depolymerization process is contemplated that results in a waste plastic containing feed being converted into one or more materials in a form that can be molecules, chemical compounds, monomers, oligomers, or combinations thereof, and where the resulting material is further converted into a useful material/product, e.g., a useful material or product that can be used in one or more reaction schemes to produce a recycle content polymer. In embodiments, the depolymerization process can be a pyrolysis process where waste plastic is pyrolyzed to form a pyoil and/or pygas that is/are utilized in further processes to make useful chemical materials/products. In embodiments, the depolymerization process can be any process where waste plastic is converted to one or more useful materials/products, e.g., where waste plastic is a feedstock source (direct or indirect) to one or more unit operations or pieces of equipment in a refinery or other chemical manufacturing process. In embodiments, recycle content (for a recycle content polymer) can be derived from a combination of different depolymerization processes.

In one or more embodiments, the polymer with recycle content includes polymer that may be marketed or certified as containing recycle content regardless of monomer or upstream monomer reactant or feedstock component source. In such embodiments, polymer with recycle may be formed from non-recycled monomer, or feedstock that does not include depolymerization products. In such embodiments, the polymer with recycle content may be referred herein to as an “allotment recycle content polymer”. As used herein, the phrase “allotment recycle content polymer” describes a recycle content polymer that may be identified as having recycle content through receiving a recycle content allotment (e.g., through a recycle content credit or a recycle content allocation) from a recycle content inventory. As used herein, the term “recycle content allocation” is a type of recycle content allotment, where the entity or person supplying the composition sells or transfers the composition to the receiving entity, and the entity that made the composition has an allotment at least a portion of which can be associated with the composition sold or transferred by the supplying entity to the receiving entity. The supplying entity or person can be controlled by the same entity or a variety of affiliates that are ultimately controlled or owned at least in part by a parent entity (“Family of Entities”), or they can be from a different Family of Entities. The term “recycle content credit” is a type of recycle content allotment, where the allotment is available for sale or transfer by other than the supplier of the composition that is transferred to the receiving entity or person. The term “allotment” or “recycle content allotment” refers to a theoretically calculated content of recycled mass originating from waste plastic that would be converted to some useable chemical composition based on a mass balance approach that accounts for stoichiometry and yields associated with converting the waste plastic to the usable chemical composition and including any intermediate compositions that would need to be formed. By way of non-limiting example, polymers may be certified as including recycle content (and the amount of recycle content determined/certified) under procedures and certifications issued by an independent certification entity, e.g., the International Sustainability & Carbon Certification (ISCC), a global, independent agency for tracking sustainable content in a variety of industries.

In one embodiment or in combination with any of the mentioned embodiments, a recycle content allocation may be received by an entity and deposited into a recycle inventory, and a credit may be withdrawn from the inventory and applied in conjunction with the entity's manufacture and/or sale of an article. This would be the case where an allocation is created for example from a recycle plastic and deposited into a recycle inventory and deducting a recycle content value from the recycle inventory and applying it to a composition (or article formed therefrom). In such as system, one need not trace back on a strict molecular basis the source of a reactant compound or composition or related article to identify it as having recycle content.

Recycle content inventories, allotments, allocations, credits and the like generally, as well as more particularly with respect to recycle content cellulose esters, are described for example in present assignee's PCT Published Applications WO2020/242921; WO2021061918A1; WO2021092296A1 and U.S. Published Patent Application No. 2020/0247910, all expressly incorporated herein by reference. Recycle content inventories, allotments, allocations, credits and the like generally, as well as more particularly with respect to recycle content polyesters and polyester monomers, are described for example in present assignee's PCT Published Applications WO 2021/021855; WO2021/092291 and WO2021/092293, the contents and disclosure of which are hereby incorporated herein by reference.

Though different approaches for identifying polymers as having recycle content have been described herein, it should be understood that such approaches may be implemented in combination. By way of non-limiting example, a polymer with recycle content may include physical recycle content polymer and allotment recycle content polymer. In one or more such embodiments, the polymer with recycle content may include at least 1 mole % or at least 2 weight % or at least 3 mole % or at least 4 weight% or at least 5 mole % or at least 6 weight% or at least 7 mole % or at least 8 weight% at least 9 mole % or at least 10 weight% physical recycle content polymer based on total weight recycle content polymer. The articles of the present invention, in general, include polymer with recycle content. The articles of the present invention are not necessarily limited and may generally of any type or structure; may be formed by any known methods of manufacture; and may be useful in a wide variety of applications and functions. In one or more embodiments, the polymer with recycle content is a component of a polymer alloy or blend or composition.

Properties and characteristics of various polymers with recycle content are set forth herein as well as in the Tables below. Table 1 lists properties for various recycle content polyesters. Table 2 lists properties for various polymer blends or polymer alloys including recycle content polyesters as well as a recycle content cellulose ester and an impact-modified recycle content cellulose ester.

TABLE 1

| | | Crystallized | | Amorphous | | | | | |
|---|---|---|---|---|---|---|---|---|---|
| | Method | PET | PCT | PET | PCT | PETG | PCTM | | |
| Density (g/cm\hat{ }3) | ASTM D792 | 1.34 | 1.21 | 1.34 | 1.21 | 1.27 | 1.18 | 1.18 | 1.17 |
| Biocontent | USDA | | | | | | | | |
| | Certified | | | | | | | | |
| Recycle Content | ISCC | Up to | Up to | Up to | Up to | Up to | Up to | Up to | Up to |
| | Certified | 100% | 100% | 100% | 100% | 100% | 100% | 100% | 100% |
| Tensile Elongation at | ISO 527 | 2-3 | 2-3 | 100 | 144 | 130 | 210 | 210 | 140 |
| Break (% strain) | | | | | | | | | |
| Flexural Modulus (MPa) | ISO 178 | 2400-3150 | 2100-2250 | 2360 | 1574 | 2100 | 1580 | 1550 | 1590 |
| Izod Notched Impact | ISO 180 | — | — | 2.75 | — | 8.63 | 84.3 | 96.1 | 63.7 |
| 23° C. (kJ/m\hat{ }2) | | | | | | | | | |
| Izod Notched Impact | ISO 180 | — | — | 1.4 | — | 4.4 | 11 | 20 | 14 |
| −30° C. (kJ/m\hat{ }2) | | | | | | | | | |
| Hardness Rockwell R | ASTM D785 | — | — | 105 | 100 | 115 | 111 | 112 | 115 |
| Heat Deflection | ASTM D648 | — | — | 66 | 84 | 72 | 94 | 99 | 109 |
| Temperature | | | | | | | | | |
| 0.45 MPa (66 psi) (° C.) | | | | | | | | | |
| Heat Deflection | ASTM D648 | — | — | 61 | 70 | 68 | 81 | 85 | 92 |
| Temperature | | | | | | | | | |
| 1.80 MPa (264 psi) (° C.) | | | | | | | | | |
| Transparent Color | ASTM D1003 | — | — | 84.9 | — | 91 | 91 | 90 | 92 |
| Transmittance (%) | | | | | | | | | |
| Transparent Color | ASTM D1003 | — | — | 2.85 | — | 1 | 1 | 1 | 1 |
| Haze (%) | | | | | | | | | |

| | | | | | |
|---|---|---|---|---|---|
| Crystalline Melting | DSC | 250 | 290 | 250 | 290 |
| Point, C. | | | | | |

TABLE 2

| | | Amorphous | | | | | |
|---|---|---|---|---|---|---|---|
| | Method | PCTM Alloy 1 | PCTM Alloy 2 | PCTM Alloy 3 | PCTM Alloy 4 | CE | mCE |
| Density (g/cm\hat{ }3) | ASTM D792 | 1.2 | 1.18 | 1.15-1.16 | 1.2-1.31 | 1.23 | 1.22 |
| Biocontent | USDA Certified | | | | | up to 50 wt % | up to 50 wt % |
| Recycle Content | ISCC Certified | Up to 80% | Up to 100% | Up to 100% | Up to 100% | up to 50 wt % | up to 50 wt % |
| Tensile Elongation at | ISO 527 | 130 | 180 | 150 | 200-250 | 21 | 22 |
| Break (% strain) | | | | | | | |
| Flexural Modulus (MPa) | ISO 178 | 2400 | 1450 | 1650-1850 | 1700-2000 | 2160 | 1950 |
| Izod Notched Impact | ISO 180 | 70 | 105 | <=84 | <=96 | 8.04 | 19.6 |
| 23° C. (kJ/m\hat{ }2) | | | | | | | |
| Izod Notched Impact | ISO 180 | 15 | 14 | <=11 | <=20 | 6.47 | 7.84 |
| −30° C. (kJ/m\hat{ }2) | | | | | | | |
| Hardness Rockwell R | ASTM D785 | 120 | 102 | <=112 | <=115 | 108 | 102 |
| Heat Deflection Temperature | ASTM D648 | 137 | 88 | 88-91 | 80-90 | 116 | 114 |
| 0.45 MPa (66 psi) (° C.) | | | | | | | |
| Heat Deflection Temperature | ASTM D648 | 125 | 75 | 76-79 | 60-72 | 102 | 100 |
| 1.80 MPa (264 psi) (° C.) | | | | | | | |
| Transparent Color | ASTM D1003 | 88 | 81 | — | — | 93 | 92 |
| Transmittance (%) | | | | | | | |
| Transparent Color Haze (%) | ASTM D1003 | 0.8 | 0.3 | — | — | 2 | 3 |

In the above Tables 1 and 2, PET is Polyester Terephthalate; PCT is Polycyclohexylenedimethylene terephthalate; PETG is glycol modified polyester terephthalate; PCTM is glycol modified polycyclohexylenedimethylene terephthalate including 2,2,4,4-Tetramethyl-1,3-cyclobutanediol; PCTM Alloy 1 represents blends of PCTM with up to 80 wt. % polycarbonate; Alloy 2 represents blends of PCTM with up to 80 wt % acid modified PCT; Alloy 3 represents blends of PCTM with up to 80 wt. % styrene copolymers including acrylonitrile butadiene styrene; and Alloy 4 represents blends of PCTM with up to 80 wt. % PET, PBT, or PCT. Above alloys with PCTM can be with virgin or recycled secondary polymers and can include modifiers, compatibilizers, or other additives.

CEs are cellulosic polymers including acetate, butyrate, propionate, and combinations; mCE are the same with impact or other modifiers including plasticizers.

In one or more embodiments, the article of the present invention is a polymeric article. As used herein, the phrase “polymeric article” is intended to include articles that are at least 25% or at least 30% or at least 35% or at least 40% or at least 45% or at least 50% or predominantly polymer by weight based on total weight of the article. Useful articles include, but are not limited to, extruded, calendered and/or molded articles including, but not limited to, compression molded articles, injection molded articles, extruded articles, cast extrusion articles, solution cast articles, profile extrusion articles, melt spun and solution spun articles, thermoformed articles, extrusion molded articles, injection blow molded articles, injection stretch blow molded articles, extrusion blow molded articles, additive manufactured or 3D-printed articles and extrusion stretch blow molded articles. Articles are generally meant to include article components.

In one or embodiments, the article of the present invention may be a “simple” article. In general, “simple” is intended to describe articles that typically have essentially one element, component or part and is intended to contrast with so-called “composite” articles described below. Non-limiting examples of simple articles may include monolithic films and sheets; molded or extruded articles formed from a single composition, fibers, fabrics and the like. In one or more embodiments, the article of the present invention is a simple article or a simple polymeric article that includes polymer with recycle content.

In one or more embodiments, the article of the present invention may be a composite article, and more particularly a composite article comprising two or more article components, wherein at least one of said article components includes polymer with recycle content. As used herein, the phrase composite article intended to describe articles that typically have essentially more than one element, component or part and is intended to contrast with so-called “simple” articles described above. Non-limiting examples of composite articles include laminated articles, coated articles, and core/shell articles, each of which are described in more detail below. Composite articles are also contemplated to include articles that include multiple simple articles and/or composite articles in combination. In one or more embodiments, the article of the present invention is a composite article or a composite polymeric article that includes polymer with recycle content.

In one or more embodiments, the article may be a laminated article. As used herein, the phrase “laminated article” is intended to include generally articles having multiple film layers bonded together by pressure, welding, co-extrusion, adhesive or similar means. In such an embodiment, each layer, as well as any adhesive layer, may each constitute an article component. Accordingly, in one or more embodiments, at least one of said film layers or one of said optional adhesive layers comprises a polymer with recycle content.

In one or more embodiments, the article may be a coated article. As used herein, the phrase “coated article” is intended to include generally articles that include a substrate with a coatable surface and one or more at least partial coating layers thereon. In such an embodiment the coating(s), the substrate, and any component of the substrate may each constitute an article component. Accordingly, in one or more embodiments, at least one of the substrate and the one or more coating layers comprises a polymer with recycle content.

In one or more embodiments, the article may be a core/shell article. As used herein, the phrase core/shell article is intended to include generally a core of a first material substantially surrounded by a shell of a second material. In such an embodiment, the core, the shell and any core or shell component may each constitute an article component. Accordingly, in one or more embodiments, at least one of said core and said shell comprises a polymer with recycle content. In one or more embodiments, the core includes a polymer with recycle content.

In one or more embodiments, the article of the present invention may be a printable article. The printable article may include a printable surface suitable for receiving a print layer thereon while the printed article may include a printable surface and a print layer formed thereon. Print layers may include any layer that includes a print material such as an ink, colorant layer or the like or that may display for example an image, logo, pattern, color or the like.

In one or more embodiments, the article of the present invention may be a decorative article. The decoratable article may include a decoratable surface suitable for receiving a decorative layer thereon while the decorative article may include a decoratable surface and a decorative layer formed thereon. Decorative layers may generally include any layer intended to provide or display a decorative, artistic or aesthetically desirable effect.

In one or more embodiments, the article of the present invention may be an electroplatable article or an electroplated article. The electroplatable article may include an electroplatable surface suitable for receiving an electroplate layer thereon while the electroplated article may include an electroplatable surface and an electroplate layer formed thereon. Electroplate layers may include any layer applied by a known and conventional electrodeposition process.

While specific article types and classifications have been described above, the various categories do not and are not intended to limit the present invention and that other articles are contemplated to be within the spirit and scope of the present invention. For example, composite articles may include so-called “foam-in-place” articles including a substrate and a foam formed thereon that are produced according to methods wherein a substrate such as a fabric is inserted into a mold or similar device and foam-creating ingredients are then injected into the mold and foamed, with the resulting foam filling interstices and bonding to the substrate. Further, it will be appreciated that the categories described are general in nature and may be interpreted to overlap in scope.

The articles of the present invention are useful in a wide variety of technical fields, markets, products and product components, cut components. Non-limiting examples may include automotive components and accessories, including interior and exterior decorative trim components such as center consoles, storage boxes, glove boxes, dashboards, instrument panels, doors, seat backs, pillars, overhead consoles, spoilers, mirrors and the like; electronics components and accessories such as connectors, housings, keyboards and the like; power tools, hand tools and lawn/garden tools, components and accessories such as handles, housings, batteries, charging stations; medical devices and device components; and food containers such as bottles, trays and the like.

A number of important advantages of the present invention may be exemplified in the articles described herein. In coated, printed, electroplated and similar articles, substrate surface energy, smoothness, uniformity and consistency between material lots are critical to the successful, uniform application of coating/electroplated/print layers and the long-term efficacy of those layers in use over time. Similarly, composite articles such as laminates and foam-in-place articles demand strong, uniform and lasting adhesion between layers or portions. In specific applications, articles must demonstrate consistent welding behavior between welded components and consistent sound/thermal insulation/dampening performance where desired. The articles of the present invention have successfully demonstrated such characteristics while facilitating increased use of recycle content materials.

In another aspect, the present invention is directed to a method for marketing or offering for sale or selling an article with recycle content. In this aspect, the method of the present invention includes: (a) procuring a supply of polymer with recycle content, wherein the polymer with recycle content is preferably selected from a group consisting of (i) a recycle content polyester and (ii) a recycle content cellulose ester; (b) forming an article or article component using at least a portion of said polymer with recycle content; and (c) offering for sale said article with recycle content, said offering step including generally describing said article or said article component as including, made with, made from or using said polymer with recycle content. In one or more embodiments, the polymer with recycle content is selected from a group consisting of (i) a recycle content polyester and (ii) a recycle content cellulose ester. In one or more embodiments, the recycle content polyester includes a thermoplastic cycloaliphatic copolyester that includes diol residues of 1,4-cyclohexanedimethanol (CHDM) and 2,2,4,4-tetramethyl-1,3-cyclobutanediol (TMCD). It should be understood that the descriptions and definitions related to an element described in one aspect of the present invention expressly support, describe and define that element insofar as it is present in other aspects of present invention.

In another aspect, the present invention is directed to a method for reducing the fossil fuel use associated with article manufacture. In this aspect, the method of the present invention includes (a) procuring a supply of polymer with recycle content; and (b) forming an article or article component using at least a portion of said polymer with recycled content. In one or more embodiments, the polymer with recycle content is selected from a group consisting of (i) a recycle content polyester and (ii) a recycle content cellulose ester. In one or more embodiments, the recycle content polyester includes a thermoplastic cycloaliphatic copolyester that includes diol residues of 1,4-cyclohexanedimethanol (CHDM) and 2,2,4,4-tetramethyl-1,3-cyclobutanediol (TMCD). In general, one of ordinary skill will be appreciate that, in reducing fossil fuel use, the method of the present invention correspondingly reduces the carbon footprint associated with manufacture of the subject. Accordingly, the method of the present invention may also be described in one or more embodiments as a method for reducing the carbon footprint associated with article manufacture. It should be understood that the descriptions and definitions related to an element described in one aspect of the present invention expressly support, describe and define that element insofar as it is present in other aspects of present invention.

In another aspect, the present invention is directed to a method for manufacture of a circular economy polymer. In this aspect, the method of the present invention includes: (a) receiving allotment transfer credits; and (b) allocating said transfer credits in the manufacture of a polymer with recycle content. In one or more embodiments, the polymer with recycle content of step (b) is a thermoplastic cycloaliphatic copolyester that includes diol residues of 1,4-cyclohexanedimethanol (CHDM) and 2,2,4,4-tetramethyl-1,3-cyclobutanediol (TMCD). As utilized herein, the phrase “circular economy” is as defined and described herein. It should be understood that the descriptions and definitions related to an element described in one aspect of the present invention expressly support, describe and define that element or feature insofar as it is present in other aspects of present invention.

In one or more aspects or embodiments, an important feature of the present invention is its facilitation of processing of more complex plastic waste streams of a form or type that reclaimers such as those in the PET reclaiming industry cannot or do not accept for processing. Accordingly, in one or more embodiments, the receiving step (a) of the method of the present invention includes generating allotment transfer credits by processing a material that excludes or that includes no more than 20% by weight or no more than 15% by weight or no more than 10% by weight or no more than 5% by weight reclaimable plastic waste. Reclaimable plastic waste is defined as polymer material that is recoverable or reclaimable from a previous utility and sourced in substantially polymeric form for re-use. Reclaimable plastic waste includes materials reformable to increase molecular weight or IV, such as through solid state polymerization, but where polymer bonds are not significantly or purposefully broken down. Reclaimable plastic waste is typically processed to form reclaimed plastic waste using mechanical recycling techniques. Non-limiting examples of reclaimable plastic waste include materials formable from mechanically recycled clear PET bottles. The phrase “reclaimable plastic waste” is intended to include materials typically accepted by reclaimers for processing under typical mechanical recycling methods.

In embodiments, articles (or components of articles) can be provided that contain (or are made with) recycle content polymer (as described herein) and have one or more properties that is/are superior to similar articles (or components) that contain (or are made with) mechanically recycled polymers. For example, articles (or components) as described herein can have improved surface characteristics, such as one or more of the following: better printability, higher scratch resistance, lower or higher coefficient of friction (as desired), better adhesion to itself or other polymeric articles/components (e.g., for laminate structures), etc., compared to similar articles/components containing (or are made with) mechanically recycled polymers. In embodiments, articles (or components) as described herein can have improved properties compared to similar articles/components containing (or are made with) mechanically recycled polymers, where the articles (or components) as described herein have the same or higher recycle content than such similar articles/components.

### Closed Loop (or Takeback) Process

In aspects, the processes for providing recycle content described herein can be or include a closed loop process. In embodiments, the closed loop process for providing a recycle content polymer is provided where at least a portion of the depolymerization feed, used in a depolymerization process to generate recycle content for the recycle content polymer, is obtained from the same recycle content polymer type (“same type waste plastic”). In one embodiment, at least a portion of the product from the closed loop process (“closed loop product”) is used to make a recycle content polymer, for use in an article, through one or more intermediate products, at least one of which is made at least in part from the closed loop product, and at least a portion of the feedstock to the depolymerization process is obtained from the same article type.

A closed loop process does not require that all of the same type waste plastic (and optional other plastics) in the feedstock be obtained from the same articles ultimately made from the resulting closed loop product, nor does it require that all of the resulting closed loop product is used to ultimately make the same articles as employed in the feedstock to the depolymerization process. Rather, as long as at least a portion of the recycle articles used as a feedstock and at least a portion of the closed loop product is used to make at least a portion of intermediate products that through several reaction steps make up at least a portion of the same (recycle content) polymer used to make the same type of article, the process qualifies as including a closed loop process.

A closed loop process is differentiated by the open loop process in that the renewed articles made in the open loop process are different from the end of life articles recycled as a feedstock material to the depolymerization process.

The match between recycled articles and renewed material made in a closed loop system does not have to be compositionally identical. Rather, the family of products and articles are a match.

The depolymerization process can be operated as a closed loop process and an open loop process simultaneously. For example, depolymerization product made from feedstock obtained from end of life articles or products can be split, some used to make intermediate chemicals and polymers that ultimately will be used to make renewed polymers or articles that are the same as the polymers or articles contained in the end of life articles that are recycled as material in the feedstock to the depolymerization process, and some to make renewed articles and products that are different from the end of life articles and polymers used as material for a feedstock to the depolymerization process.

In one embodiment, there is provided a feedstock containing an article, optionally size reduced (r-article) and a closed loop product used to make a chemical that is used in a reaction scheme to make a renewed article, which can be a polymer or end use application, (n-article), wherein the r-article and n-article are the same. If the closed loop is with respect to polyesters or CE polymers, the polyesters and CE polymers, respectively, are considered to be in the closed loop process even though they are not compositionally identical, provided that the polyesters and CE polymers have the same kind of repeating units. For example, polyesters may have varying mole percentages of monomer residues and CAP's may have varying degrees of proponyl substitution, and different variations can be used in a variety of applications, but nevertheless such polymers are in a closed loop system since they each contain for polyesters: the same type of monomers, and for CAP's: they contain cellulose, acetate, and proponyl moieties.

In one embodiment, the closed loop process is one in which the recycle article used in the feedstock has the same application family as the renewed article. For example, a recycle PCTM copolyester as a feedstock is obtained from a molded automotive interior part that is also ultimately made into a renewed molded automotive interior part containing PCTM copolyester; or a recycle cellulose diacetate as a feedstock is obtained from a textile that is also ultimately made into a renewed textile containing cellulose diacetate, or r-eyeglass frames to r-eyeglass frames.

As described herein, a closed loop solution to landfill disposal is also provided by taking polymer scrap from an article manufacturing process, feeding it to a depolymerization process to make depolymerization product (by any of the processes described herein), which is then used in a reaction scheme to make a recycle content polymer of the same type. In embodiments, polymer with recycled content (by mass balance allocation) is provided using same type polymer scrap as a source of recycled content.

In embodiments, ground or powder scrap polymer material can be introduced to a depolymerization process and consumed to produce a depolymerization product, as described herein. The depolymerization product may then be used in one or more reaction schemes to manufacture a recycle content polymer of the same type (as the scrap polymer material), thus closing the loop and providing for content derived from same type polymer sources. In embodiments, the scrap material may include one or more materials selected from other polymer types.

In embodiments, the depolymerization feed comprises automotive shredder residue (ASR), which is mixed plastic waste from crushed (or recycled) vehicles. In embodiments, the ASR containing depolymerization feed is a source for recycle content (as described herein) for articles for automotive (or vehicle) applications. In embodiments, the depolymerization feed comprises automotive (or vehicle) PET fabric, textile, composite and/or carpet waste. In embodiments, a depolymerization feed containing such automotive (or vehicle) waste is a source for recycle content (as described herein) for articles for the same applications.

In embodiments, use of a recycle allocation credit based on recycle CE content syngas to provide a closed loop process recycle content in ophthalmic articles is provided.

### Additional Claim Supporting Description—First Embodiment

In a first embodiment of the present technology there is provided an article comprising a polymer with recycle content, said polymer with recycle content selected from a group consisting of (i) a recycle content polyester; and (ii) a recycle content cellulose ester.

The first embodiment described in the preceding paragraph can also include one or more of the additional aspects/features listed in the following bullet pointed paragraphs. Each of the below additional features of the first embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein said article is a laminated article comprising one or more film layers and optionally one or more adhesive layers and wherein at least one of said film layers or one of said optional adhesive layers comprises said polymer with recycle content.
wherein said article is a coated article comprising a substrate and one or more coating layers and wherein at least one of said substrate and said one or more coating layers comprises said polymer with recycle content.
wherein said article is a core/shell article comprising a core substantially surrounded by a shell and wherein at least one of said core and said shell comprises said polymer with recycle content.
   wherein said core comprises said polymer with recycle content.
wherein said polymer with recycle content is a component of a recycle polymer composition.
   wherein said recycle polymer composition further includes a reinforcing agent or filler.
wherein said polymer with recycle content is present in said article in an amount of at least 20% by weight based on the total weight of the article.
wherein said recycle content polyester comprises a recycled content copolyester, wherein said recycle content copolyester is a thermoplastic cycloaliphatic copolyester that includes diol residues of 1,4-cyclohexanedimethanol (CHDM) and 2,2,4,4-tetramethyl-1,3-cyclobutanediol (TMCD).
wherein said article is a printed article that comprises a printable surface and a print layer formed thereon. 1

wherein said article is an electroplated article comprising a substrate and an electroplate layer formed thereon.
wherein said article is a “foam-in-place” article comprising a substrate and a foam formed thereon.
wherein said article is a molded article.
wherein said article is an extruded article.
wherein said article is a fabric.
wherein said article is an additive manufactured article.
wherein said article is a power tool, hand tool or component thereof or accessory therefor.
wherein said article is an automotive interior or exterior part.
wherein said article is a housing, connector or accessory for an electronics device.
wherein said polymer with recycle content includes polymer formed from feedstock that includes monomer or upstream monomer reactants or other feed materials formed from a depolymerization process.
   wherein said depolymerization process is a methanolysis process.
   wherein said depolymerization process is a glycolysis process.
   wherein said depolymerization process is a recycle content syngas formation process.
wherein said recycle content polymer is an allotment recycle content polymer.
wherein said recycle content polymer comprises physical recycle content polymer and allotment recycle content polymer.

### Additional Claim Supporting Description—Second Embodiment

In a second embodiment of the present technology there is provided a method for marketing an article with recycle content, said method including: (a) procuring a supply of polymer with recycle content, said polymer with recycle content selected from a group consisting of (i) a recycle content polyester, wherein said recycle content polyester is a thermoplastic cycloaliphatic copolyester that includes diol residues of 1,4-cyclohexanedimethanol (CHDM) and 2,2,4,4-tetramethyl-1,3-cyclobutanediol (TMCD); and (ii) a recycle content cellulose ester; (b) forming an article or article component using at least a portion of said polymer with recycle content; and (c) offering for sale said article with recycle content, said offering step including generally describing said article as including, made with, made from or using said polymer with recycle content.

### Additional Claim Supporting Description—Third Embodiment

In a third embodiment of the present technology there is provided a method for reducing the fossil fuel use associated with article manufacture, said method including (a) procuring a supply of a recycled content polymer, said polymer with recycle content selected from a group consisting of (i) a recycle content copolyester, wherein said recycle content copolyester is a thermoplastic cycloaliphatic copolyester that includes diol residues of 1,4-cyclohexanedimethanol (CHDM) and 2,2,4,4-tetramethyl-1,3-cyclobutanediol (TMCD); and (ii) a recycle content cellulose ester; and (b) forming an article or article component using at least a portion of said polymer with recycled content.

### Additional Claim Supporting Description—Fourth Embodiment

In a fourth embodiment of the present technology there is provided a method for manufacture of a circular economy polymer said method comprising (a) receiving allotment transfer credits and (b) allocating said transfer credits in the manufacture of a polymer with recycle content.

The fourth embodiment described in the preceding paragraph can also include the additional aspects/features as follows:
wherein said receiving step (a) includes generating allotment transfer credits by processing a feedstock that includes plastic waste and that includes no more than 20% by weight reclaimable plastic material.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

That which is claimed is:

1. A method of making an article having recycle content, said method comprising: (a) procuring a supply of a recycled content polymer, said polymer with recycle content selected from a group consisting of (i) a recycle content copolyester, wherein said recycle content copolyester is a thermoplastic cycloaliphatic copolyester that includes diol residues of 1,4-cyclohexanedimethanol (CHDM) and 2,2,4,4-tetramethyl-1,3-cyclobutanediol (TMCD); and (ii) a recycle content cellulose ester; and (b) forming an article or article component using at least a portion of said polymer with recycle content, wherein the recycle content includes recycle content obtained by processing a feedstock that includes plastic waste and said plastic waste includes no more than 20% by weight reclaimable plastic material.

2. The method according to claim 1, wherein said article is a laminated article comprising one or more film layers and optionally one or more adhesive layers and wherein at least one of said film layers or one of said optional adhesive layers comprises said polymer with recycle content.

3. The method according to claim 1, wherein said article is a coated article comprising a substrate and one or more coating layers and wherein at least one of said substrate and said one or more coating layers comprises said polymer with recycle content.

4. The method according to claim 1, wherein said article is a core/shell article comprising a core substantially surrounded by a shell and wherein at least one of said core and said shell comprises said polymer with recycle content.

5. The method according to claim 4, wherein said core comprises said polymer with recycle content.

6. The method according to claim 1, wherein said polymer with recycle content is present in said article in an amount of at least 20% by weight based on the total weight of the article.

7. The method according to claim 1, wherein said article further includes a reinforcing agent or filler.

8. The method according to claim 1, wherein said article is a printed article that comprises a printable surface and a print layer formed thereon.

9. The method according to claim 1, wherein said article is an electroplated article comprising a substrate and an electroplate layer formed thereon.

10. The method according to claim 1, wherein said article is a “foam-in-place” article comprising a substrate and a foam formed thereon.

11. The method according to claim 1, wherein said article is a power tool, hand tool or component thereof or accessory therefor.

12. The method according to claim 1, wherein said article is an automotive interior or exterior part.

13. The method according to claim 1, wherein said article is a housing, connector or accessory for an electronics device.

14. The method according to claim 1, wherein said polymer with recycle content includes polymer formed from feedstock that includes monomer or upstream monomer reactants or other feed materials formed from a depolymerization process.

15. The method according to claim 14, wherein said depolymerization process is a methanolysis process.

16. The method according to claim 14, wherein said depolymerization process is a glycolysis process.

17. The method according to claim 14, wherein said depolymerization process is a recycle content syngas formation process.

18. The method according to claim 1, wherein said recycle content polymer is an allotment recycle content polymer.

19. The method according to claim 1, wherein said recycle content polymer comprises physical recycle content polymer and allotment recycle content polymer.
